(19) United States
(12) Patent Application Publication
(10) Pub. No.: US 2026/0348405 A1
(43) Pub. Date: Nov. 5, 2026

(54) MULTIFUNCTION HYDRAULIC VALVE WITH SELECTIVE BYPASS FOR SERIES OPERATION

(71) Applicant: Austin J. Karst, Montrose, MN (US)

(72) Inventor: Austin J. Karst, Montrose, MN (US)

(21) Appl. No.: 19/410,059

(22) Filed: Dec. 5, 2025

Related U.S. Application Data
(60) Provisional application No. 63/798,611, filed on May 2, 2025.
(60) Provisional application No. 63/804,068, filed on May 12, 2025.

(51) Int. Cl. F15B 13/04; F15B 11/05; F16K 11/07

(52) U.S. Cl. CPC F15B 13/0402; F15B 11/055; F16K 11/07; F15B 2013/041

(57) ABSTRACT

A hydraulic system comprises a tank storing hydraulic fluid and a first pump outputting hydraulic fluid flow. A first hydraulic actuator with first and second fluid ports receives hydraulic fluid for bidirectional movement. A second hydraulic actuator with third and fourth fluid ports receives hydraulic fluid for bidirectional movement. A first control valve controlling the first hydraulic actuator operates in first and second states. The control valve includes a control element, first supply connection connected to the pump via supply passage, first free flow connection connected to the pump via supply passage, second free flow connection connectable to downstream hydraulic component, first and second working connections, first working passage connecting first working connection to first fluid port, second working passage connecting second working connection to second fluid port, bypass connection, and bypass passage connecting bypass connection to tank.

### COPYRIGHT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants, make no claim to any trademarks referenced.

### CROSS-REFERENCE TO RELATED APPLICATIONS

This application is a Utility Patent application claiming priority to U.S. Provisional Patent Application Ser. No. 63/804,068, filed on May 12, 2025, and to U.S. Provisional Patent Application Ser. No. 63/798,611, filed on May 2, 2025, which are incorporated by reference herein in their entirety.

### BACKGROUND OF THE INVENTION

### 1) Field of the Invention

The present disclosure relates to hydraulic systems for controlling hydraulic actuators of machines, and more particularly to a multifunction hydraulic valve with selective bypass passages that remain available across neutral and actuated valve positions to enable series operation while preventing actuator stalling.

### 2) Description of Related Art

Various hydraulic valve architectures are known in the art, including systems configured for series or open center operation. For example, some hydraulic valve systems utilize spool type valves and include provisions for flow control and actuator management. While such systems provide certain benefits, they do not address the multifunction performance and flow path flexibility offered by the embodiments described herein and, in particular, do not provide state-dependent bypass connectivity that remains available to at least one working connection across neutral and actuated spool positions in a series-connected circuit.

Certain machines, such as but not limited to skid steers or compact wheel loaders, may include a boom mechanically coupled to one or more hydraulic boom cylinders, a bucket that is mechanically coupled to one or more hydraulic bucket cylinders, and an auxiliary actuator configured to operate additional auxiliary attachments.

The hydraulic cylinders are typically actuated by corresponding control valves, often implemented with control elements such as hydraulic spools, located in respective sections of the machine's hydraulic system.

For example, to raise or lower the boom, a first control valve may be shifted from a neutral state to a second or third state, resulting in the extension or retraction of the boom cylinders.

Similarly, a second control valve may be shifted to actuate the bucket cylinders for curling or dumping operations.

A third control valve may be provided to operate an auxiliary hydraulic actuator in the same manner.

In typical hydraulic systems for such machines, each control section includes a spool, various fluid connection points within a cavity, and internal fluid passages within the valve body. When the spool in a given section is in a neutral or non-actuated position, hydraulic fluid from the pump flows through the control section and is routed downstream to the next section. This sequential flow continues through successive sections, allowing hydraulic fluid to be delivered to each downstream section when the preceding spools remain in their neutral positions.

This type of hydraulic system is commonly referred to as an open center valve configuration, in which hydraulic fluid flows through a central passage when the spools are in the neutral position. This central passage is often referred to as the free flow passage or free flow line.

When the spool of the first control section is shifted to a second state, hydraulic fluid is directed to one side of the boom cylinder, causing the piston to move. As the piston extends or retracts, fluid is displaced from the opposite side of the cylinder and returns to the first control spool. The first control spool then directs this return flow to the second control section via the free flow passage or line.

This hydraulic system configuration is commonly referred to as a series circuit, in which multiple functions are connected hydraulically in series. When an upstream actuator is operated, the return flow from that actuator is directed through the control valve to a downstream section, allowing a second actuator to be operated using the flow displaced from the first, allowing for simultaneous operation.

Those skilled in the art will recognize that the series connection may be implemented either within the spool itself or within the valve body, depending on the specific valve architecture.

One challenge associated with series circuits arises during simultaneous operation of multiple actuators, such as the boom and bucket cylinders. If the actuator controlled by the second control spool reaches the end of its stroke while the second spool remains shifted, two undesirable phenomena may occur.

The first is the stalling of the first function, as fluid flow is restricted by the halted motion of the second actuator. The second issue is the potential for unintended motion of the first actuator. When the downstream actuator reaches its end of stroke, pressure may build up in the series channel. This backpressure can cause the first actuator to drift in the opposite direction, resulting in movement contrary to the operator's intent. In such conditions, the operator has limited options to restore the intended motion without manually re-positioning the downstream control spool to recreate a suitable flow path.

The first problem described above may be addressed by incorporating either a restriction or a pressure-controlled valve positioned such that series flow can be diverted to tank when the first control spool is shifted and the second actuator reaches the end of its stroke. This configuration allows the first actuator to continue moving, as the return fluid is provided with an alternative flow path to tank.

In the prior art, this solution is implemented so that the additional flow path opens only when the control spool is shifted from its neutral position into an actuated state. This approach is primarily used to ensure that the working connections remain closed in neutral, preventing unintended actuator movement. While this configuration limits downstream pressure, it improves controllability by enabling continued upstream movement.

The second problem is addressed in the prior art by incorporating check valves into both series channels within the valve. These check valves prevent reverse flow from the second working section to the first, allowing the operator to maintain the second function in a stalled position while operating the first. This eliminates the need for the operator to manually return the second control spool to a neutral or partially neutral position to avoid unintended movement.

The present invention recognizes the need for further improvement in multifunction hydraulic systems utilizing series circuit architectures, particularly in enhancing simultaneous function control, reducing unintended actuator behavior, and improving flow management across various valve states.

### BRIEF SUMMARY OF THE INVENTION

The present disclosure in one form is directed to a hydraulic system for controlling a hydraulic actuator of a machine and a hydraulic valve for series connected multifunction hydraulic circuits in which return flow from one actuator is utilized to supply another actuator.

The hydraulic system is for controlling at least one hydraulic actuator. The hydraulic system includes a tank configured to store hydraulic fluid and a pump operable to deliver fluid at a load induced pressure. A first hydraulic actuator is configured to control a mechanical device, such as a boom linkage system of a machine. The actuator includes a piston and rod assembly that is movable in a first direction and an opposing second direction.

The first actuator is operated by directing hydraulic fluid into either side of the actuator, as determined by a control valve fluidly connected to the actuator. The control valve selectively delivers flow to one side of the actuator, while return flow from the opposite side is directed back to the control valve. This return flow is then routed downstream to a second control valve.

When the second control valve is in the neutral state, the return flow continues along a sequential path, such as to a third control valve or to tank. However, when the second control valve is shifted from neutral, the return flow from the first actuator is instead directed to a second actuator via the second control valve.

During simultaneous operation of both actuators, it is possible for the second actuator to reach the end of its stroke or become stalled. In this scenario, as described in the preceding problem statement, the first actuator may also stall due to the absence of a fluid path for the return flow.

With no exit path available, pressure builds up in the “series” or “free flow” gallery, and this elevated pressure is communicated back to the first actuator. As a result, the pressure on the delivery side of the first actuator increases, ultimately causing the pump flow to be diverted over the system relief valve, as is understood by those skilled in the art.

The present invention aims to mitigate this issue through the configuration of a bypass passage or multitude of bypass passages allowing the return flow to be returned back to the tank while at least one bypass passage remains functionally available in neutral and in at least one actuated state of the corresponding control valve so that return flow can be directed both toward tank and toward a downstream series path.

In one aspect of the disclosure, the first hydraulic actuator is configured to include a bypass passage that is fluidly connected to one of the working passages via a first control valve. The working passage is then connected to the actuator through an interface, such as a hose or steel pipe. The connection between the bypass passage and the working passage is present when the first control valve is in a neutral state, remains connected in a second state, and is disconnected in a third state. In the second state, this connection allows hydraulic fluid to be bypassed to tank while simultaneously maintaining the series flow path through the free flow gallery, thereby enabling hydraulic fluid to be delivered sequentially to another control valve or to tank, as applicable.

In another implementation, the bypass passage is fluidly connected to both a first and a second working passage via the first control valve. In this case, the bypass connection with the second working connection is present in the neutral state, remains connected in a third state, and is disconnected in a second state—operating in opposition to the bypass connection behavior associated with the first working passage. In the third state, this connection allows hydraulic fluid to be bypassed to tank while simultaneously maintaining the series flow path through the free flow gallery, thereby enabling hydraulic fluid to be delivered sequentially to another control valve or to tank, as applicable.

In another implementation, the bypass passage includes a restriction configured to limit the amount of hydraulic fluid flow directed through the bypass to tank.

In another implementation, the first control valve is configured to include a restriction between the first working passage and the bypass passage, and a corresponding restriction between the second working passage and the bypass passage. These restrictions are equal in size or flow capacity to ensure balanced operation between the two working passages.

In one aspect of the disclosure, the bypass passage is split into two separate bypass passages, with one bypass fluidly connected to the first working connection and the other bypass fluidly connected to the second working connection. Each bypass operates according to the same state dependent logic described above, wherein the connection between the bypass and the corresponding working passage is maintained or disconnected based on the state of the control valve.

In another implementation, a pressure control valve is disposed in one or both of the bypass passages, allowing hydraulic fluid to flow to tank when a predetermined pressure is reached within the series passage or free flow passage. This pressure condition generally arises during multifunction operation, where the return flow from the first actuator becomes pressurized due to the load induced by the actuation of a second actuator.

In another implementation an electronically controlled valve is placed in the bypass allowing for oil to flow to tank when an electronic signal is provided to the valve. This selective signal may be selectable by the operator or triggered by an even such as a multifunction command in which more than one control valve is commanded.

In another implementation a restriction is disposed in either or both of the lines in which the restrictions are of equal area when implemented in both lines.

In one aspect of the disclosure, the bypass passage is split into four separate bypass passages, with two bypasses fluidly connected to the first working connection and the other two bypass fluidly connected to the second working connection. Each pair of bypasses operates according to the same state dependent logic described above, wherein the connection between the bypass and the corresponding working passage is maintained or disconnected based on the state of the control valve.

In another implementation each of the four bypasses include a restriction providing a redundant operation in the case that one orifice is plugged with contamination and optimal operation when the orifices are not plugged and allow oil to freely pass through.

In another implementation, multiple pressure control valves are disposed in each bypass allowing for a stepped response to a rise in system pressure or load so that higher pressure stages progressively open additional bypass capacity as needed.

In another implementation, an orifice is disposed in parallel with a pressure control valve to provide a response that may be clipped when a given pressure in the series channel is achieved allowing a controlled blend of fixed-orifice flow and pressure-responsive flow regulation.

In one aspect of the disclosure, one or more check valves are disposed in the free flow gallery or series channels located between the first and second control valve, preventing the backflow of fluid from the second control valve to the first.

In another implementation, one or more check valves are disposed in the free flow gallery or series channels located between a second and third control valve, preventing the backflow of fluid from the second control valve to the first.

In one aspect of the disclosure a pilot operated check valve, counterbalance valve, or the like is placed in the first working passage, configured to be closed when the first control valve is in the neutral position and receives a pilot signal from the second working passage to open when the valve shifts from neutral to a second or third state.

In another implementation a pilot operated check valve, counterbalance valve, or the like is placed in the second working passage, configured to be closed when the first control valve is in the neutral position and receives a pilot signal from the first working passage to open when the valve shifts from neutral to a second or third state.

In one aspect of the disclosure a pilot operated check valve, counterbalance valve, or the like is placed in the third working passage, configured to be closed when the second control valve is in the neutral position and receives a pilot signal from the fourth working passage to open when the valve shifts from neutral to a second or third state.

In another implementation a pilot operated check valve, counterbalance valve, or the like is placed in the fourth working passage, configured to be closed when the second control valve is in the neutral position and receives a pilot signal from the third working passage to open when the valve shifts from neutral to a second or third state.

In another implementation, an electronically controlled valve is disposed in any of the four working passages described above and is commandable in the neutral, second, or third state of the control valve, or independently in response to an operator input or control signal, to allow fluid communication with the bypass.

In one aspect of the disclosure the components described above are contained in a plurality of valve bodies or hydraulic components.

In one aspect of the disclosure the components described above are contained in a single valve body.

According to an aspect of the present disclosure, a hydraulic system for a machine is provided. The hydraulic system comprises a tank operable to store a hydraulic fluid and a first pump operable to output a flow of hydraulic fluid. A first hydraulic actuator having a first fluid port and a second fluid port receives the hydraulic fluid to move the first hydraulic actuator in respective first and second directions. A second hydraulic actuator having a third fluid port and a fourth fluid port receives the hydraulic fluid to move the second hydraulic actuator in respective first and second directions. A first control valve is disposed to control the first hydraulic actuator and is controllable among at least a first state and a second state. The first control valve comprises a control element, a first supply connection fluidly connected to the first pump via a supply passage, a first free flow connection fluidly connected to the first pump via the supply passage, a second free flow connection fluidly connectable to a downstream hydraulic component, a first working connection and a second working connection, a first working passage fluidly connecting the first working connection to the first fluid port, a second working passage fluidly connecting the second working connection to the second fluid port, at least one bypass connection, and at least one bypass passage fluidly connecting the at least one bypass connection to the tank. At least one of the first working connection, the second working connection, and the bypass connection is positioned proximate to the control element at one or more positions thereon and is selectively connectable through one or more internal passage configurations within the first control valve. A second control valve is disposed downstream of the first control valve and is controllable among at least a first state and a second state to control the second hydraulic actuator. The second control valve is fluidly connected to the first control valve via the second free flow connection and comprises a third free flow connection fluidly connected to the second free flow connection, a fourth free flow connection fluidly connectable to a further downstream hydraulic component or to the tank, a third working connection and a fourth working connection, a third working passage fluidly connecting the third working connection to the third fluid port, and a fourth working passage fluidly connecting the fourth working connection to the fourth fluid port. In the first state of the first control valve, the first free flow connection is fluidly connected to the second free flow connection to deliver fluid output from the first pump through the first control valve to the third free flow connection of the second control valve, the first supply connection is blocked, and the first working connection and the second working connection are each fluidly connected to the at least one bypass connection so that fluid from the first hydraulic actuator is returnable to the tank via the at least one bypass passage. In the second state of the first control valve, a fluid connection between the first working connection and the at least one bypass connection is at least partially closed, the first working connection is fluidly connected to the first supply connection to allow fluid communication between the first pump and the first working passage to supply the first hydraulic actuator through the first fluid port, the second working connection is fluidly connected to the at least one bypass connection, and the second working connection is fluidly connected, directly or indirectly, to the second free flow connection through one or more internal passages, bypass passages, check valves, pressure-control valves, or other flow-permissive elements of the valve, thereby allowing fluid communication among the second working passage, the at least one bypass passage, and the second free flow connection.

According to other aspects of the present disclosure, the hydraulic system may include one or more of the following features. In a third state of the first control valve, a fluid connection between the second working connection and the at least one bypass connection may be at least partially closed, the second working connection may be fluidly connected to the first supply connection to allow fluid communication between the pump and the second working passage, the first working connection may be fluidly connected to the at least one bypass connection, and the first working connection may be fluidly connected, directly or indirectly, to the second free flow connection through one or more internal passages, bypass passages, check valves, pressure control valves, or other flow permissive elements of the valve, thereby allowing fluid communication between the first working passage, the at least one bypass passage, and the second control valve via the second free flow connection. The second control valve may be configured in like manner to the first control valve and may comprise the third free flow connection and the fourth free flow connection corresponding to the first and second free flow connections of the first control valve, the third and fourth working connections corresponding to the first and second working connections, the third and fourth working passages corresponding to the first and second working passages, the second supply connection corresponding to the first supply connection, and at least one bypass connection and at least one bypass passage corresponding to those of the first control valve, the second control valve being operable among corresponding first, second, and third states. The second control valve may be operable in a third state corresponding to the third state of the first control valve. The at least one bypass passage may comprise a first and a second bypass passage, each independently associated with the first working connection of the first control valve or the third working connection of the second control valve, and a third and a fourth bypass passage, each independently associated with the second working connection of the first control valve or the fourth working connection of the second control valve. A first and a second restriction may be disposed between the first working connection or the third working connection and the first and second bypass passages, respectively, or a third and a fourth restriction may be disposed between the second working connection or the fourth working connection and the third and fourth bypass passages, respectively, each restriction being configured to limit flow from the corresponding working connection to the tank without impeding flow from the corresponding working connection to a free flow connection. The at least one bypass passage may comprise a common bypass passage shared by both the first and second working connections of the first control valve or both the third and fourth working connections of the second control valve, and at least one restriction may be disposed within the common bypass passage. A first bypass passage may be associated with the first working connection of the first control valve or the third working connection of the second control valve and a second bypass passage may be associated with the second working connection of the first control valve or the fourth working connection of the second control valve, and a respective restriction may be disposed within at least one of the first or second bypass passages. A first and a second bypass passage may be associated with the first working connection of the first control valve or the third working connection of the second control valve and a third and a fourth bypass passage may be associated with the second working connection of the first control valve or the fourth working connection of the second control valve, and a respective restriction may be disposed within at least one of the first, second, third, or fourth bypass passages. At least one pressure control valve may be disposed in at least one bypass passage, the pressure control valve comprising at least one of a check valve, a relief valve, a sequence valve, or a compensator, and being configured to direct flow from one or more of the working connections of the first or second control valve to the tank through the at least one bypass passage when a predetermined pressure is exceeded. The control element of the first control valve may comprise a spool, and fluid communication between at least one of the first or second working connections and the at least one bypass connection in the first state and in at least one of the second or third states may be provided by a bypass feature formed on the spool, the bypass feature comprising at least one of a notch, a spiral groove, a lateral groove, or another machined flow path distinct from nominal spool to bore clearance. At least one valve selected from a pilot operated check valve, a pilot operated sequence valve, a counterbalance valve, and an electronically controlled valve may be disposed in the first or second working passage of the first control valve or the third or fourth working passage of the second control valve, the at least one valve being configured to remain closed in the first state of the corresponding control valve and to open in the second or third state when hydraulically piloted or electronically commanded. At least one pilot operated spool may be disposed in the first or second working passage of the first control valve or the third or fourth working passage of the second control valve, the pilot operated spool being configured to block the corresponding working passage in the first state of the corresponding control valve and to open the corresponding working passage in the second or third state when hydraulically piloted or electronically commanded. At least one check valve may be disposed between the second free flow connection of the first control valve and the third free flow connection of the second control valve or between the fourth free flow connection of the second control valve and a fifth free flow connection of a third control valve, the at least one check valve being configured to prevent reverse flow from a downstream free flow connection to an upstream free flow connection. At least one check valve may be disposed within at least one series passage arranged in parallel with a free flow passage between the second free flow connection of the first control valve and the third free flow connection of the second control valve or between the fourth free flow connection of the second control valve and a fifth free flow connection of a third control valve, the at least one check valve being configured to prevent reverse flow from a downstream free flow connection to an upstream free flow connection. The at least one bypass passage may comprise a first bypass passage and a second bypass passage, and a first bypass check valve may be disposed between the first bypass passage and the second free flow connection and a second bypass check valve may be disposed between the second bypass passage and the second free flow connection, each bypass check valve being configured to prevent reverse flow from the second free flow connection toward the corresponding bypass passage. Except for the pump, the tank, and the hydraulic actuators, the hydraulic system may be integrated into a hydraulic valve.

According to another aspect of the present disclosure, a hydraulic valve section is provided. The hydraulic valve section comprises a first supply interface configured to receive pressurized fluid, a first free flow passage fluidly connecting the first supply interface to a first free flow connection port and a second free flow connection port, an outlet supply interface fluidly connected to a third free flow connection port through a second free flow passage, at least one pressure supply passage fluidly connectable to the first and second free flow connection ports, a first working connection port fluidly connected to a first work port through a first working passage, a second working connection port fluidly connected to a second work port through a second working passage, a first bypass connection port fluidly connected to a first bypass passage, a second bypass connection port fluidly connected to a second bypass passage, at least one flow control element disposed in at least one of the first bypass passage or the second bypass passage, the flow control element being configured to regulate flow between the corresponding bypass passage and a corresponding tank passage, at least one bypass to free flow passage fluidly connecting at least one of the first bypass passage or the second bypass passage to the third free flow connection port in parallel with the corresponding flow control element, the bypass to free flow passage being configured to allow return flow toward the outlet supply interface while the corresponding flow control element directs flow toward the corresponding tank passage, and a control spool disposed in a spool cavity and movable among at least a neutral state and a plurality of actuated states. The control spool is configured, in the neutral state, to provide fluid communication between the first and second free flow connection ports and the third free flow connection port and to provide fluid communication between the first working connection port and the first bypass connection port and between the second working connection port and the second bypass connection port, and in at least one actuated state to connect a pressure supply passage to one of the first or second working connection ports while maintaining fluid communication between the other working connection port and the corresponding bypass connection port so that return flow is deliverable toward the outlet supply interface and toward the corresponding tank passage.

According to other aspects of the present disclosure, the hydraulic valve section may include one or more of the following features. The hydraulic valve section may further comprise a first flow control element disposed in the first bypass passage and a second flow control element disposed in the second bypass passage, each flow control element being configured to regulate flow between the corresponding bypass passage and the corresponding tank passage. The hydraulic valve section may further comprise at least one bypass check valve disposed between at least one of the first bypass passage or the second bypass passage and the third free flow connection port, the at least one bypass check valve being configured to prevent reverse flow from the third free flow connection port toward the corresponding bypass passage. A first bypass check valve may be disposed between the first bypass passage and the third free flow connection port and a second bypass check valve may be disposed between the second bypass passage and the third free flow connection port, and outlets of the first and second bypass check valves may be fluidly connected to the third free flow connection port through a free flow passage. The hydraulic valve section may further comprise a load check valve disposed between at least one supply passage connected to the first and second free flow connection ports and the at least one pressure supply passage, the load check valve being configured to permit flow from the at least one supply passage to the at least one pressure supply passage when pressure exceeds a predetermined bias and to prevent reverse flow. The control spool may comprise a first bypass feature configured to provide fluid communication between the first working connection port and the first bypass connection port in the neutral state and a second bypass feature configured to provide fluid communication between the second working connection port and the second bypass connection port in the neutral state, each bypass feature comprising at least one of a notch, a spiral groove, a lateral groove, or another machined flow path distinct from nominal spool to bore clearance. The hydraulic valve section may further comprise work port pressure control valves fluidly connected between corresponding work port branch passages and low-pressure tank ports, each work port pressure control valve being configured to allow flow from the corresponding work port to the corresponding low pressure tank port when pressure at the work port exceeds a predetermined value.

These and other objects, features, and advantages of the present invention will become more readily apparent from the attached drawings and the detailed description of the preferred embodiments, which follow.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 illustrates a hydraulic system with multiple control valves for controlling hydraulic actuators, according to aspects of the present disclosure.

FIG. 2 depicts a hydraulic valve circuit with split bypass connections for series operation.

FIG. 3 illustrates the hydraulic valve circuit of FIG. 2 with multiple parallel bypass passages, according to aspects of the present disclosure.

FIG. 4 depicts a hydraulic circuit with restrictions in bypass passages for flow control.

FIG. 5 illustrates the hydraulic circuit of FIG. 4 with restrictions disposed between bypass connections and tank passages.

FIG. 6 depicts a hydraulic circuit with pressure control valves in the bypass passages.

FIG. 7 illustrates a hydraulic circuit incorporating pilot operated check valves in working passages.

FIG. 8 depicts the hydraulic circuit of FIG. 1 with a check valve between control valves.

FIG. 9 illustrates a side view of a working machine incorporating the hydraulic system.

FIG. 10 depicts a detailed hydraulic circuit diagram of a valve section with bypass check valves.

FIG. 11A illustrates a top cross-sectional view of the valve section of FIG. 10 in a neutral state.

FIG. 11B illustrates a front cross-sectional view of the valve section of FIG. 10 in a neutral state.

FIG. 12A depicts a top cross-sectional view of the valve section of FIG. 10 in an actuated state.

FIG. 12B depicts a front cross-sectional view of the valve section of FIG. 10 in an actuated state.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

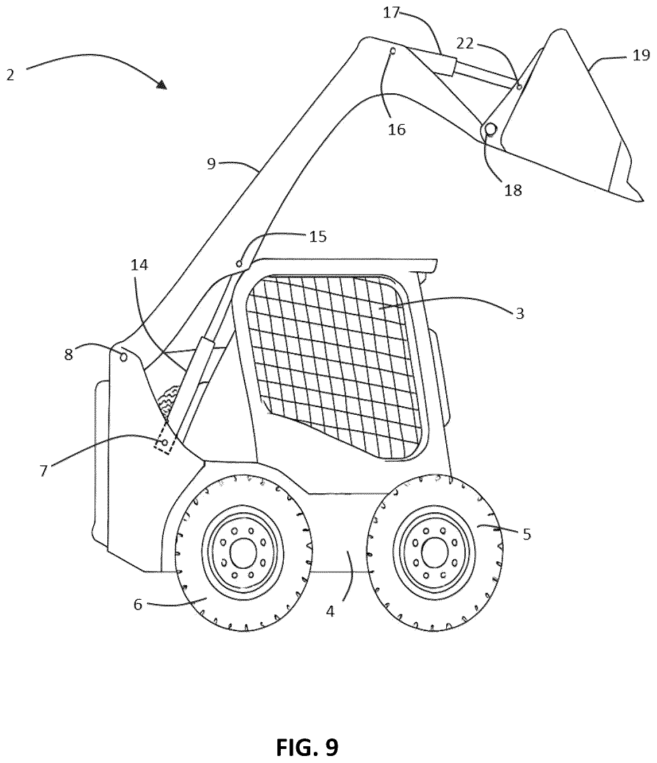

FIG. 9 provides a side view of a working machine 2 according to embodiments of the present invention. The machine includes a cab 3 configured to house an operator, operator controls, and other key components necessary for machine operation. It should be understood that a cab 3 is not required for a machine to be considered a working machine within the context of the present invention.

A chassis 4 serves as the main structural frame of the machine, supporting the cab 3, wheels 5 and 6, hydraulic components, boom, and powertrain. The wheels 5 and 6 may be implemented in various configurations, such as a wheeled or tracked undercarriage, and are not intended to limit the scope of the present invention.

The chassis 4 includes a pivot point 7, to which the base end of the hydraulic boom cylinder 14 is pinned, allowing the cylinder to rotate about the pivot point 7. The chassis 4 also includes a boom pivot point 8, to which the main lift boom 9—commonly referred to as the “boom” and referred to as such hereafter—is pinned, enabling rotation about the boom pivot 8. The rod end of the hydraulic boom cylinder 14 is coupled to the boom 9 at a pivot point 15.

Extension of the hydraulic boom cylinder 14 causes the boom 9 to rotate counterclockwise about the boom pivot 8, commonly referred to as lifting the boom. Retraction of the cylinder causes the boom 9 to rotate clockwise about the boom pivot 8, which is generally referred to as lowering the boom.

The boom 9 also includes two additional pivot points. One is the bucket hydraulic cylinder pivot point 16, where the base end of the hydraulic bucket cylinder 17 is attached. The bucket 19 is attached to the boom 9 at pivot point 18. The rod end of the hydraulic bucket cylinder 17 shares a pivot point 22 with the bucket 19.

When the hydraulic bucket cylinder 17 is extended, the bucket 19 rotates clockwise about its pivot point 18, a motion commonly referred to as dumping the bucket. When the cylinder is retracted, the bucket 19 rotates counterclockwise about pivot point 18, commonly referred to as curling the bucket.

The hydraulic boom cylinder 14 and hydraulic bucket cylinder 17 each include a base end and a rod end, separated by a piston connected to a rod. Hydraulic fluid is supplied to the base end via a port to extend the cylinder. When the cylinder is extended, fluid from the rod end exits the cylinder as return flow, which is utilized in various embodiments of the present invention. The same flow behavior applies when the cylinder is retracted, with fluid being supplied to the rod end and discharged from the base end.

Multifunction hydraulic valve systems provide control for hydraulic actuators in series-connected circuits where return flow from one actuator is utilized to supply another actuator. These systems address flow management challenges that arise during simultaneous actuator operation, particularly when downstream actuators reach the end of their stroke or become stalled. In series circuits, multiple functions are connected hydraulically in series such that when an upstream actuator is operated, return flow from that actuator is directed through a control valve to a downstream section, allowing a second actuator to be operated using the flow displaced from the first.

The series connection enables simultaneous operation but creates challenges when multiple actuators operate concurrently. When an actuator controlled by a downstream control valve reaches the end of its stroke while the control valve remains shifted, two undesirable phenomena occur. The first is stalling of the upstream function, as fluid flow is restricted by the halted motion of the downstream actuator. The second issue is potential unintended motion of the upstream actuator, where pressure buildup in the series channel causes backpressure that can cause the upstream actuator to drift in the opposite direction.

Bypass passages provide alternative flow paths that address these challenges by allowing return fluid to be directed to tank when control valves are shifted and downstream actuators reach the end of their stroke. This configuration allows upstream actuators to continue moving as return fluid is provided with an alternative flow path to tank. The bypass passages remain functionally available across neutral and actuated valve positions, maintaining connectivity to at least one working connection to ensure continued flow capability during multifunction operation.

Referring to FIG. 9, a machine 2 includes a cab 3 configured to house an operator and operator controls. A chassis 4 serves as the main structural frame of the machine 2, supporting the cab 3 and other components. The chassis 4 is supported by a front wheel 5 and a rear wheel 6, which are implemented in various configurations, such as a wheeled or tracked undercarriage. The chassis 4 includes a cylinder pivot point 7 and a boom pivot point 8. A boom 9 is pivotally connected to the chassis 4 at the boom pivot point 8. A boom cylinder 14 extends between the cylinder pivot point 7 on the chassis 4 and a boom cylinder pivot point 15 on the boom 9.

Extension of the boom cylinder 14 causes the boom 9 to rotate counterclockwise about the boom pivot point 8, commonly referred to as lifting the boom. Retraction of the boom cylinder 14 causes the boom 9 to rotate clockwise about the boom pivot point 8, generally referred to as lowering the boom. The boom 9 includes a bucket cylinder pivot point 16 where a bucket cylinder 17 is attached. A bucket 19 is attached to the boom 9 at a bucket pivot point 18. The bucket cylinder 17 extends between the bucket cylinder pivot point 16 and a bucket cylinder rod pivot point 22 on the bucket 19.

When the bucket cylinder 17 is extended, the bucket 19 rotates clockwise about the bucket pivot point 18, a motion commonly referred to as dumping the bucket. When the bucket cylinder 17 is retracted, the bucket 19 rotates counterclockwise about the bucket pivot point 18, commonly referred to as curling the bucket. Additional attachments such as a hydraulic trencher, grapple bucket, or other hydraulically operated tools are installed in place of the bucket 19, with the bucket cylinder 17 still used to tilt the attachment in the fore/aft direction about the bucket pivot point 18.

Those skilled in the art are familiar with the operating principles of hydraulic cylinders and their application in a variety of machines and linkage systems. This example is not intended to limit the scope of the present invention, but rather to illustrate one implementation within a working machine.

For simplicity, the hydraulic system is described using a single valve in the following examples; however, this is not intended to limit the invention, as the system may comprise a plurality of valves fluidly connected to one another.

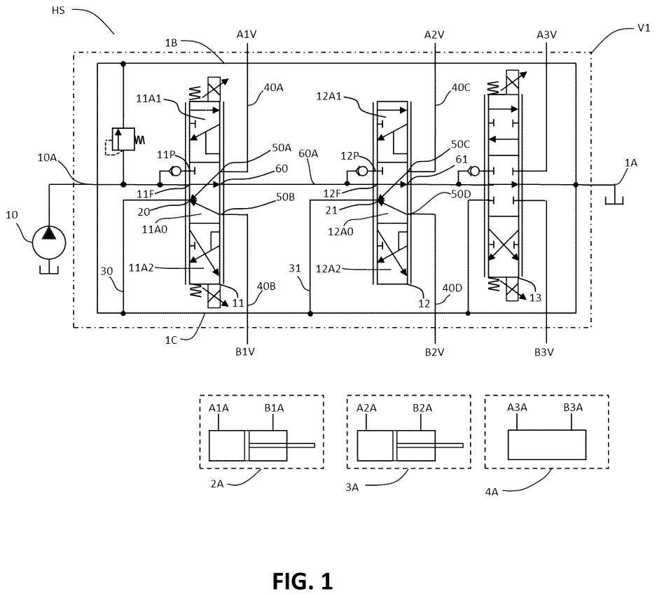

As shown in FIG. 1. the hydraulic system HS is configured to control the boom 9 by supplying oil to the hydraulic boom cylinder 14 which is represented schematically as a hydraulic boom cylinder 2A with a base port A1A and a rod port B1A. The bucket 19 is controlled by the hydraulic bucket cylinder 17 which is represented schematically by a hydraulic bucket cylinder 3A with a base port A2A and a rod port B2A.

Additional attachments, such as a hydraulic trencher or similar implements, may be installed in place of the bucket 19, with the bucket cylinder 17 still used to tilt the attachment in the fore/aft direction about pivot point 18. Some attachments, such as a trencher, may include a hydraulic motor to provide rotational drive. Other examples include a grapple bucket operable by a hydraulic cylinder or other hydraulically operated tools.

These attachments are not intended to limit the scope of the invention, but serve to illustrate the need for additional actuators and control mechanisms. In the schematic representation, such attachments are illustrated as a generic actuator box labeled 4A, having ports A3A and B3A, representing the two sides of a hydraulic actuator such as a motor or cylinder.

The hydraulic system HS includes a hydraulic pump 10 fluidly connected to a hydraulic valve V1 via a fluid conveyance element, such as a hydraulic hose or steel line. The system also includes a tank 1A, which is likewise fluidly connected to the hydraulic valve V1.

The hydraulic valve V1 includes a plurality of ports configured to connect various hydraulic actuators to the valve.

The boom base port A1V of valve V1 is fluidly connected to the base of hydraulic boom cylinder 2A at port A1A. The boom rod port B1V is fluidly connected to the rod side of hydraulic boom cylinder 2A at port B1A. While the fluid conveyance components (such as hoses or steel lines) are not shown, those skilled in the art will understand the typical methods of connecting a hydraulic valve to a hydraulic actuator. This applies throughout the present embodiment and across all disclosed embodiments.

The bucket base port A2V of valve V1 is fluidly connected to port A2A of the hydraulic bucket cylinder 3A. The bucket rod port B2V is fluidly connected to port B2A of the same cylinder.

The attachment actuator 4A includes a first port A3A, which is fluidly connected to valve port A3V via a fluid conveyance. The second port B3A of the actuator is fluidly connected to valve port B3V, also via a fluid conveyance.

In the first embodiment shown in FIG. 1, the valve V1 is composed of three separate control valves, each represented schematically by a control element, such as a spool, and operable by various means, including mechanical, hydraulic, pneumatic, or electronic actuation. The term “control valve” is not intended to be limiting and may refer to a control element, a cavity machined into a valve body, a complete cartridge valve, a complete section of a sectional valve, or the associated connections and passages necessary for the intended hydraulic function. The first control valve 11 includes multiple connections that are fluidly connectable to a plurality of passages within the valve V1.

The terms “connection” and “passage” are not intended to be limiting. A connection may describe a fluid communication point, schematically represented, that may be selectively blocked or fluidly connected to another connection point. These connections often interface with internal passages of a valve body or cavity. Such interfaces may include, but are not limited to, fluid communication between two passages via machined notches, internal bores, cast features, or other manufacturing means that establish a fluid path between two points. Similarly, the term “passage” is not intended to be limiting and may encompass any machined, cast, or otherwise formed feature that allows hydraulic fluid to flow from one location to another.

The first control valve 11 is fluidly connected to the boom base port A1V via a first working passage 40A, which is fluidly connected to a first working connection 50A. The boom rod port B1V is fluidly connected via a second working passage 40B, which is fluidly connected to a second working connection 50B. These working connections enable the transfer of hydraulic fluid to and from the hydraulic boom cylinder 2A, as previously described.

The first control valve 11 also includes a first free flow connection 11F, which is fluidly connected to the pump 10 through a supply passage 10A. The supply passage 10A is, in turn, fluidly connected to a port and associated fluid conveyance, such as a hose or steel line, between the pump and the control valve.

A second free flow connection 60 is also located within the first control valve 11 and is fluidly connected to a first free flow passage 60A. The second free flow connection 60 may be split into a plurality of connections within the valve, which ultimately merge into the first free flow passage 60A. These merged flow paths are commonly referred to as series connections by those skilled in the art.

A first supply connection 11P is also present on the first control valve 11, and is fluidly connected to the supply passage 10A. A first bypass connection 20 is provided on the first control valve and is fluidly connected to a first bypass passage 30, allowing the transfer of hydraulic fluid from the first bypass connection 20 to the tank 1A via one or more return passages, such as 1B or 1C.

The first control valve is configured to provide fluidic connections between the aforementioned ports and passages, with the specific connections being dependent on the state of the valve. In certain valve states, one or more connections may be blocked; such conditions are referred to herein as “closed,” though this terminology is not intended to limit the scope of the present invention. Multiple simultaneous connections may also be established within the valve to achieve a desired flow path between working ports.

The first state 11A0 is commonly referred to as the neutral state, which corresponds to the condition in which the first control valve 11 is not actively commanded. In this neutral state, the first supply connection 11P is typically closed, while a fluidic connection exists between the first free flow connection 11F and the second free flow connection 60, allowing hydraulic fluid to flow from the pump to downstream components, such as a sequential control valve or the tank.

In the first state 11A0, the first working connection 50A and second working connection 50B are also fluidly connected to the bypass connection 20, allowing return flow from the actuator to be directed to tank 1A via the bypass passage 30.

When commanded in one direction, the first control valve 11 transitions from the first state 11A0 (neutral) to a second state 11A1. In this state, the fluidic connection between the first working connection 50A and the bypass connection 20 is either partially or fully eliminated, depending on the displacement of the first control valve 11. A fluidic connection is established between the first supply connection 11P and the first working connection 50A, allowing hydraulic fluid from the pump 10 to be delivered to the base port A1V and downstream to A1A of the hydraulic boom cylinder 2A, resulting in cylinder extension.

Simultaneously, the fluidic connection between the first free flow connection 11F and the second free flow connection 60 is either significantly restricted or completely blocked, thereby reducing or preventing flow from the pump 10 to downstream components in the series path while still allowing a defined bypass path to remain available for at least one working connection.

Unlike conventional systems, the bypass connection 20 remains fluidly connected to at least one of the working connections 50A,50B when transitioning from one state to another. Specifically, a fluidic connection continues to exist between the second working connection 50B and the bypass connection 20 as a separate connection is established between the second working connection 50B and the second free flow connection 60 when the first control valve 11 transitions from the first state (neutral) 11A0 to the second state 11A1.

In the second state 11A1, the fluidic connection between the second working connection 50B and the second free flow connection 60 enables return flow from the rod port B1A of the hydraulic boom cylinder 2A to be directed simultaneously to tank via the bypass connection 20 and bypass passage 30, and to downstream components via the second free flow connection 60 and the free flow passage 60A.

When commanded in the opposing direction, the first control valve 11 transitions from the first state (neutral) 11A0 to a third state 11A2. In like manner, the fluidic connection between the second working connection 50B and the bypass connection 20 is either partially or fully eliminated, depending on the displacement of the first control valve 11. A fluidic connection is established between the first supply connection 11P and the second working connection 50B, allowing hydraulic fluid from the pump 10 to be delivered to the rod port B1A of the hydraulic boom cylinder 2A, resulting in cylinder retraction.

Simultaneously, the fluidic connection between the first free flow connection 11F and the second free flow connection 60 is either significantly restricted or completely blocked, thereby reducing or preventing flow from the pump 10 to downstream components in the series path.

A fluidic connection continues to exist between the first working connection 50A and the bypass connection 20 while a connection between the two is established with the second free flow connection 60.

In the third state 11A2, the fluidic connection between the first working connection 50A and the second free flow connection 60 enables return flow from the base port A1A of the hydraulic boom cylinder 2A to be directed simultaneously to tank and to downstream components via the free flow passage so that upstream motion can continue even if a downstream actuator is stalled.

The working principles described for the first control valve 11 and its corresponding passages are not limited to a single valve section and may be replicated across a plurality of valve sections, as illustrated in the second control valve 12.

The second control valve 12 operates in a similar manner to the first control valve 11 and includes a second supply connection 12P, a bypass connection 21, and a bypass passage 31. It also includes a first working connection 50C fluidly connected to a first working passage 40C, which leads to a first working port A2V; and a second working connection 50D fluidly connected to a second working passage 40D, which leads to a second working port B2V.

Additionally, the second control valve 12 includes a third free flow connection 12F and a fourth free flow connection 61, all of which are associated with the internal routing and functionality of valve 12.

The second control valve 12 is operable between multiple states to actuate the hydraulic bucket cylinder 3A, enabling it to extend and retract in a manner similar to the operation of the first control valve 11 and hydraulic boom cylinder 2A.

A third control valve 13 may also be implemented to direct flow to the attachment actuator 4A. The inclusion of this valve is not intended to limit the scope of the present invention but is provided to illustrate that different control valves, connections, and passages may be incorporated within the hydraulic system as needed.

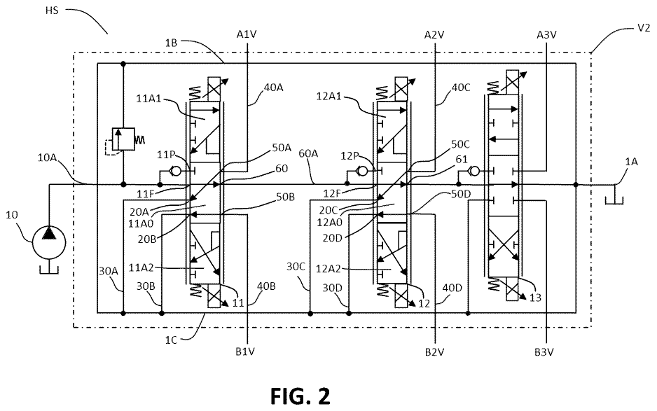

FIG. 2 provides a schematic illustration of a second embodiment, implemented within a valve V2. The valve V2 comprises three control valves, each represented schematically as a spool and operable in a manner similar to the spools described in the first embodiment.

The primary distinction between the first embodiment and the second embodiment lies in the configuration of the bypass path. In the second embodiment, the single bypass connection 20 of the first control valve 11, as described in the first embodiment, is divided into a first bypass connection 20A and a second bypass connection 20B. Similarly, the bypass passage 30 from the first embodiment is split into a first bypass passage 30A and a second bypass passage 30B.

When the first control valve 11 is in the first state (neutral) 11A0, the first working connection 50A is fluidly connected to the first bypass connection 20A, and the second working connection 50B is fluidly connected to the second bypass connection 20B. The first free flow connection 11F is fluidly connected to the second free flow connection 60, and the first supply connection 11P remains closed, as described in the first embodiment.

When the first control valve 11 is commanded to the second state 11A1, the connection between the first working connection 50A and the first bypass connection 20A is partially or completely eliminated. A fluidic connection is established between the first working connection 50A and the first supply connection 11P, allowing hydraulic fluid from the pump 10, via the first supply passage 10A, to be delivered to the first working passage 40A and first working port A1V, thereby supplying fluid to the actuator as described in the first embodiment.

Simultaneously, the fluidic connection between the first free flow connection 11F and the second free flow connection 60 is either significantly restricted or completely blocked, thereby reducing or preventing flow from the pump 10 to downstream components in the series path.

Similar to the first embodiment and unlike conventional systems, the connection between the second bypass connection 20B and the second working connection 50B remains intact while a fluidic connection is also established with the second free flow connection 60. This configuration allows return fluid from an actuator connected to the second working port B1V to flow back through the second working passage 40B, into the first control valve 11, and out through the second bypass connection 20B, ultimately returning to tank 1A via the second bypass passage 30B and either tank connection 1B,1C.

Although not required, the working principles described in connection with the first control valve 11 and its associated passages may be replicated in downstream valve sections, including but not limited to the second control valve 12 shown in FIG. 2.

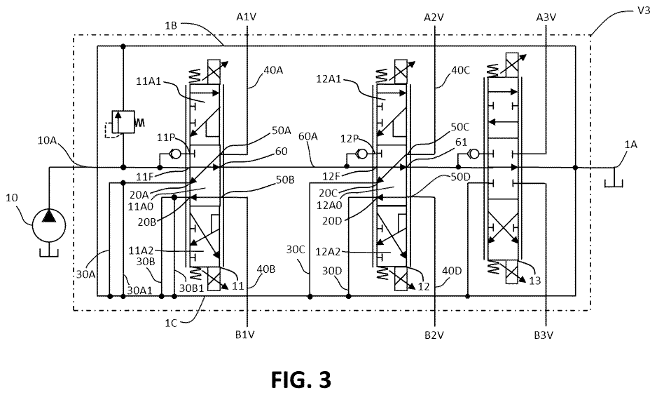

A third embodiment is depicted in FIG. 3, which illustrates a valve V3 having an architecture similar to that of the second embodiment. In this implementation, a first bypass passage 30A and a second bypass passage 30A1 are fluidly connected to the first bypass connection 20A, while a third bypass passage 30B and a fourth bypass passage 30B1 are fluidly connected to the second bypass connection 20B.

The additional bypass passages 30A1 and 30B1 are included to support a variety of system configurations and enable key functional benefits, which will be further described in the following sections.

The operating states of the third embodiment are carried over from the second embodiment, in which at least one of the working connections 50A or 50B maintains a fluidic connection with either the first bypass connection 20A or the second bypass connection 20B when the control valve is in the first, second, or third state. Those skilled in the art will readily understand the operational principles based on the teachings provided in connection with the first and second embodiments and will recognize that bypass connectivity is never simultaneously eliminated from both working connections across the full range of spool positions.

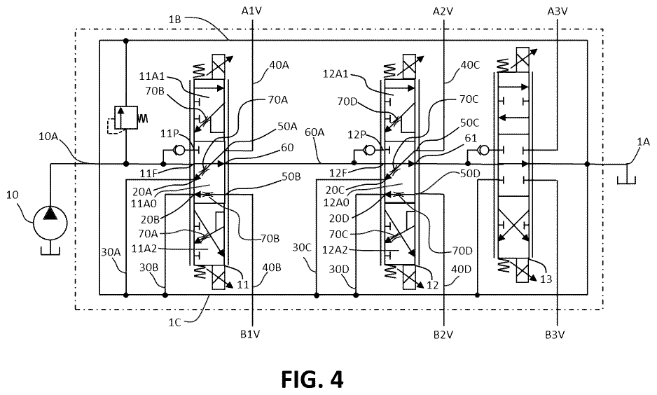

FIG. 4 illustrates an implementation of the second embodiment, which may also be utilized within the configuration of the third embodiment. A first restriction 70A is disposed between the first working connection 50A and the first bypass connection 20A, and a second restriction 70B is disposed between the second working connection 50B and the second bypass connection 20B when the first control valve 11 is in the first state (neutral) 11A0.

When the valve is shifted to the second state 11A1, the fluidic connection between the first working connection 50A and the first bypass connection 20A is partially or fully eliminated.

Simultaneously, a fluidic connection is established between the first working connection 50A and the first supply connection 11P, allowing hydraulic fluid from the pump to be delivered through the first working passage 40A. In this state, the restriction 70A has minimal to no effect on flow, as the fluidic connection between the first working connection 50A and the first bypass connection 20A is mostly or fully closed.

The second working connection 50B remains fluidly connected to the second bypass connection 20B while also establishing a fluidic connection with the second free flow connection 60. In this state, the restriction 70B remains present between the second working connection 50B and the second bypass connection 20B, but is disposed such that it does not impede flow between the second working connection 50B and the second free flow connection 60.

When the valve is shifted to the third state 11A2, the fluidic connection between the second working connection 50B and the second bypass connection 20B is partially or fully eliminated.

Simultaneously, a fluidic connection is established between the second working connection 50B and the first supply connection 11P, allowing hydraulic fluid from the pump to be delivered through the second working passage 40B. In this state, the restriction 70B has minimal to no effect on flow, as the fluidic connection between the second working connection 50B and the second bypass connection 20B is mostly or fully closed.

In this state, the first working connection 50A remains fluidly connected to the first bypass connection 20A while also establishing a fluidic connection with the second free flow connection 60. The restriction 70A remains disposed between the first working connection 50A and the first bypass connection 20A, but is configured such that it does not impede flow between the first working connection 50A and the second free flow connection 60 and thus does not interfere with series operation.

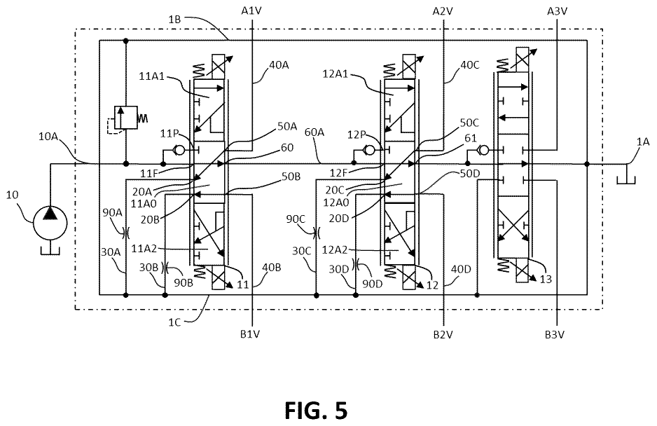

FIG. 5 illustrates an implementation of the second embodiment in which a first restriction 90A is disposed directly within the first bypass passage 30A, between the tank connection 1C and the first bypass connection 20A. The restriction 90A limits flow from the first working connection 50A to tank in the first (11A0), second (11A1), and third (11A2) valve states.

A second restriction 90B is disposed directly within the second bypass passage 30B, between the tank connection 1C and the second bypass connection 20B, and is similarly configured to restrict flow from the second working connection 50B to tank across the first (11A0), second (11A1), and third (11A2) states.

It is important to note that the implementation shown in FIG. 5 may also be applied to the third embodiment. With reference to FIG. 3, a similar arrangement may be achieved by disposing a first and second restriction in the first and second bypass passages (30A and 30A1), respectively, and a third and fourth restriction in the third and fourth bypass passages (30B and 30B1), respectively, in a like manner.

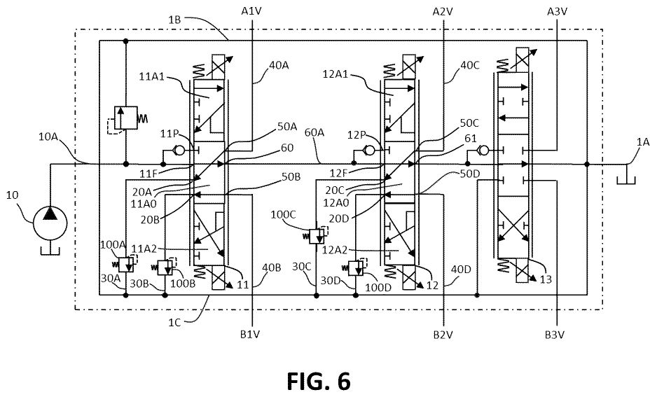

FIG. 6 illustrates an implementation of the second embodiment in which a first pressure control valve 100A is disposed directly within the first bypass passage 30A, between the tank connection 1C and the first bypass connection 20A. The pressure control valve 100A regulates flow from the first working connection 50A to tank in the first (11A0), second (11A1), and third (11A2) valve states by opening only when a predetermined pressure is exceeded.

A second pressure control valve 100B is disposed directly within the second bypass passage 30B, between the tank connection 1C and the second bypass connection 20B, and is similarly configured to regulate flow from the second working connection 50B to tank across the first (11A0), second (11A1), and third (11A2) states based on a pressure threshold.

It is important to note that the implementation shown in FIG. 5 may also be applied to the third embodiment. With reference to FIG. 3, a similar arrangement may be achieved by disposing a first and second pressure control valve within the first and second bypass passages (30A and 30A1), respectively, and a third and fourth pressure control valve within the third and fourth bypass passages (30B and 30B1), respectively, in a like manner.

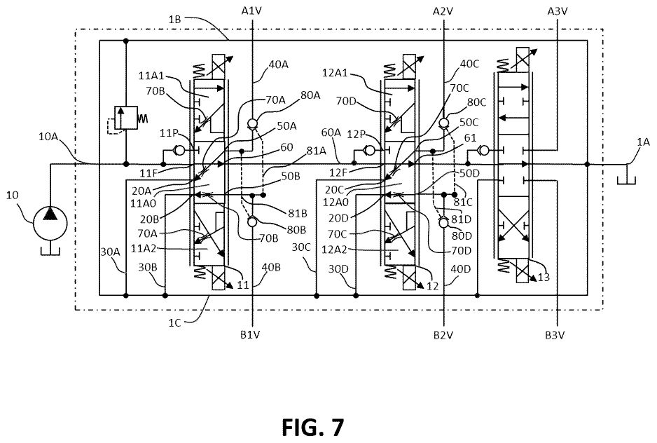

FIG. 7 illustrates an implementation that may be applied to any of the embodiments and configurations described thus far. A first pilot operated check valve 80A is disposed within the first working passage 40A, between the first working port A1V and the first working connection 50A. A pilot line 81A is connected to a location along the second working passage 40B, between the second working connection 50B and the second working port B1V, which may also include a valve.

The pilot operated check valve 80A is configured to prevent flow from the first working port A1V to the first working connection 50A when the first control valve 11 is in the first state (neutral) 11A0. In the second state 11A1, the valve 80A allows flow from the first working connection 50A to the first working port A1V. In the third state 11A2, pressure from the second working passage 40B, between the second working connection 50B and the second working port B1V, is communicated to the pilot line 81A, causing the pilot operated check valve 80A to open and permit flow from A1V to the first working connection 50A.

FIG. 7 also illustrates a second pilot operated check valve 80B disposed within the second working passage 40B, between the second working port B1V and the second working connection 50B. A pilot line 81B is connected to a location along the first working passage 40A, between the first working connection 50A and the first working port A1V, which may also include a valve.

The pilot operated check valve 80B is configured to prevent flow from the second working port B1V to the second working connection 50B when the first control valve 11 is in the first state (neutral) 11A0. In the third state 11A2, the valve 80B allows flow from the second working connection 50B to the second working port B1V. In the second state 11A1, pressure from the first working passage 40A, between the first working connection 50A and the first working port A1V, is communicated to the pilot line 81B, causing the pilot operated check valve 80B to open and permit flow from B1V to the second working connection 50B.

It should be understood that the pilot operated check valves 80A and 80B described herein are not meant to limit the scope of the invention and may alternatively be implemented using other types of pilot operated valves that perform similar functions, such as counterbalance valves, pilot operated sequence valves, or other pressure responsive or pilot actuated valve types. These alternatives are considered functionally equivalent for the purposes of the present invention and may be selected based on application specific performance requirements.

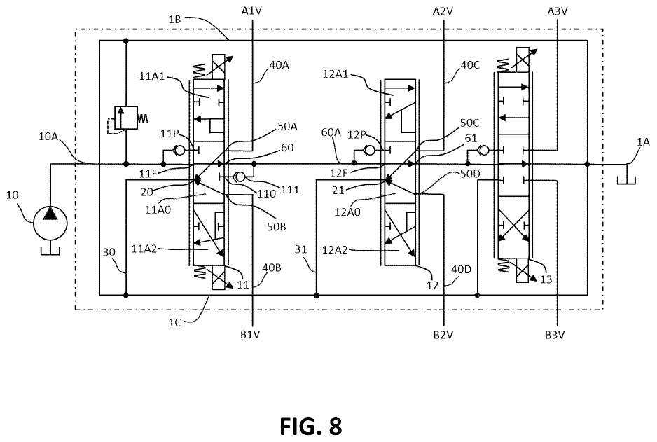

FIG. 8 illustrates an implementation in which a check valve 110 is disposed within a series channel that forms part of the free flow passage 111, located between the second free flow connection 60 of the first control valve 11 and the third free flow connection 12F of the second control valve 12. The check valve 110 is configured to prevent reverse flow from the third free flow connection 12F back to the second free flow connection 60, thereby maintaining controlled flow direction within the series circuit and preventing unintended back feeding between valve sections and may be implemented within a single gallery or within multiple parallel series channels.

It should be understood that more than one free flow passage may be provided between the second free flow connection 60 and the third free flow connection 12F. Each free flow passage may include one or more series channels, and one or more check valves may be disposed within those channels to prevent reverse flow from downstream to upstream control valves. These check valves may be selectively placed based on flow direction requirements, system layout, or specific control strategies, and may be arranged in parallel or in separate branches as needed to ensure reliable downstream priority even during multifunction operation.

The use of one or more free flow passages, series channels, and check valves between the second free flow connection 60 and the third free flow connection 12F is applicable to all of the embodiments and configurations described herein. In certain implementations, a single check valve may be disposed between 60 and 12F to prevent reverse flow, while in other cases, multiple passages and check valves may be employed to suit specific system requirements. These variations are intended to fall within the scope of the present invention.

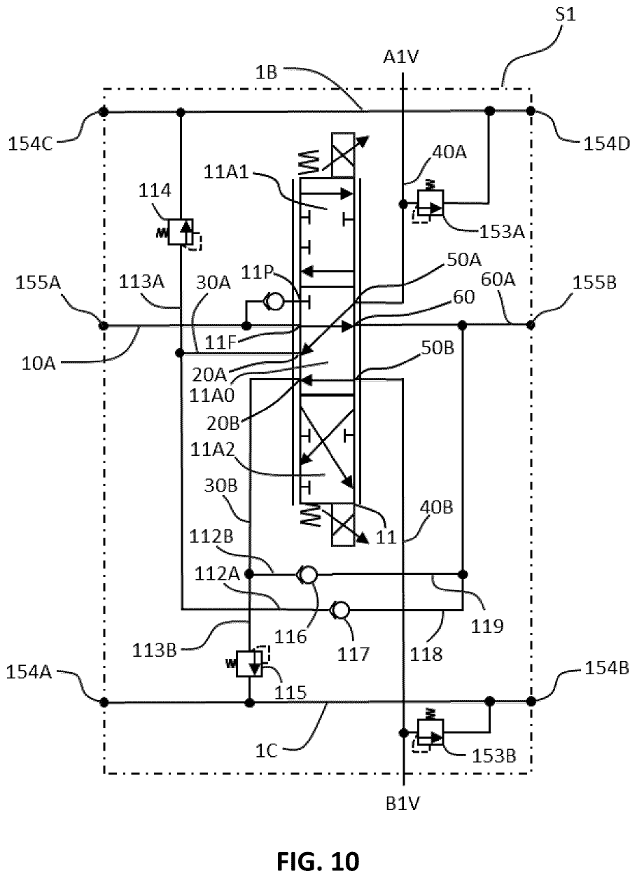

FIG. 10 illustrates an implementation that may be applied to any of the embodiments or configurations described herein, represented as a sectional valve segment S1. The section S1 is configured for modular assembly, such that multiple sections can be flanged together. In a typical arrangement, a first section is flanged to an inlet manifold and to a second section, which may represent either an intermediate or terminal section within the assembly. The final section includes a flanging interface adapted for connection to an outlet section. Those skilled in the art of sectional valve design and assembly will recognize that the general configuration of such sectional valves is well understood and therefore not the primary focus of the present invention.

The section S1 is configured to include multiple interfaces that enable fluid communication between the valve section and adjacent components, including an inlet, mid inlet, additional valve sections, or an outlet. Interfaces 154A and 154C are arranged to provide fluid communication between the section S1 and the adjoining valve component on the inlet side, which ultimately connects to a tank line. Interfaces 154B and 154D are configured to provide fluid communication between the section S1 and a subsequent section or an outlet, which are likewise connected to the tank line. Internally, interface 154A is connected to interface 154B through passage 1C, while interface 154C is connected to interface 154D through passage 1B. These passages collectively define the primary tank reference paths for section S1.

Furthermore, the section is configured to enable pressurized fluid flow between the valve section S1, the adjoining valve component on the inlet side, or outlet side via the supply interface 155A and outlet supply interface 155B respectively. 155A is connected to a supply passage 10A leading to a first free flow connection port 11F used to supply pressurized fluid to the remainder of the circuit. In common implementations of such sectional valve, 155A may connect directly to two or more supply passages in parallel that converge to individual free flow connection ports in similar likeness to 11F. Fluid flow is typically allowed to one or more supply connection ports 11P through the internal connection of a check valve configured between the supply connection port 11P and the first free flow connection port 11F.

The section S1 is configured to further include a second free flow connection port 60 and a first free flow passage 60A allowing fluid communication from the second free flow connection port 60 and the outlet supply interface 155B. A first working connection port 50A is fluidly coupled to a first working port A1V via a first working passage 40A. In like manner, a second working connection port 50B is fluidly coupled to a second working port B1V via a second working passage 40B.

The section S1 is also configured to include a first bypass connection port 20A and a second bypass connection port 20B. A first bypass passage 30A extends from the first bypass connection port 20A, and a second bypass passage 30B extends from the second bypass connection port 20B. A first flow control element 114 is fluidly connected to the first bypass passage 30A via a first drain passage 113A. The flow control element 114 is configured to regulate flow between the first bypass passage 30A and a first tank passage 1B. In the illustrated embodiment, the flow control element 114 is shown as a pressure control valve, but other flow control elements such as restrictors, orifices, valves, or compensators may be used. In parallel with the flow control element 114, a first bypass to free flow return path is provided. In the illustrated embodiment, a first bypass check valve 117 is arranged to deliver flow from the first bypass passage 30A to the first free flow connection port 60 through a first free flow bypass passage 112A and a second free flow bypass passage 118. The bypass check valve 117 prevents reverse flow from the first free flow connection port 60 back into the first bypass passage 30A.

A second flow control element 115 is fluidly connected to the second bypass passage 30B via a second drain passage 113B. The flow control element 115 is configured to regulate flow between the second bypass passage 30B and a second tank passage 1C. As with the first bypass passage, the flow control element 115 may be a pressure control valve, an orifice, a restrictor, valve, or any other flow regulating device.

The configuration of section S1 differs from previously described embodiments in that the connections between the first and second bypass connection ports 20A, 20B and the first free flow connection port 60 are implemented entirely within the valve body of section S1 using internal passages 112A, 112B, 118, and 119 and bypass check valves 117 and 116, rather than being formed exclusively by the positioning of the first control valve 11. This construction integrates the bypass to free flow routing directly into the valve section and ensures that bypass to free flow continuity is maintained independently of spool displacement.

The positioning of the first control valve 11 within the spool cavity remains similar to prior embodiments. In the neutral state 11A0, the first working connection port 50A is fluidly connected to the first bypass connection port 20A, and the second working connection port 50B is fluidly connected to the second bypass connection port 20B. These connections are formed through bypass features machined into the first control valve 11, distinct from nominal spool to bore clearance. The bypass features may be sized to maintain minimal flow to tank passages 1B and 1C via bypass passages 30A and 30B and are configured to provide predictable neutral-state bypass flow rather than relying on incidental leakage.

When the first control valve 11 transitions from the neutral state 11A0 to a second state 11A1, the connection between the first working connection port 50A and the first bypass connection port 20A is blocked, a connection is formed between the first working connection port 50A and the first supply connection port P (connected to supply passage 10A), enabling pressurized fluid to reach the first working port A1V, the second working connection port 50B remains fluidly connected to the second bypass connection port 20B, return fluid from second working port B1V continues through bypass passage 30B.

This logic is mirrored in the third state 11A2, in which, the second working connection port 50B is connected to the supply connection P, the first working connection port 50A remains connected to the first bypass connection port 20A, providing pressurized flow to second working port B1V and bypass flow from the first working port A1V.

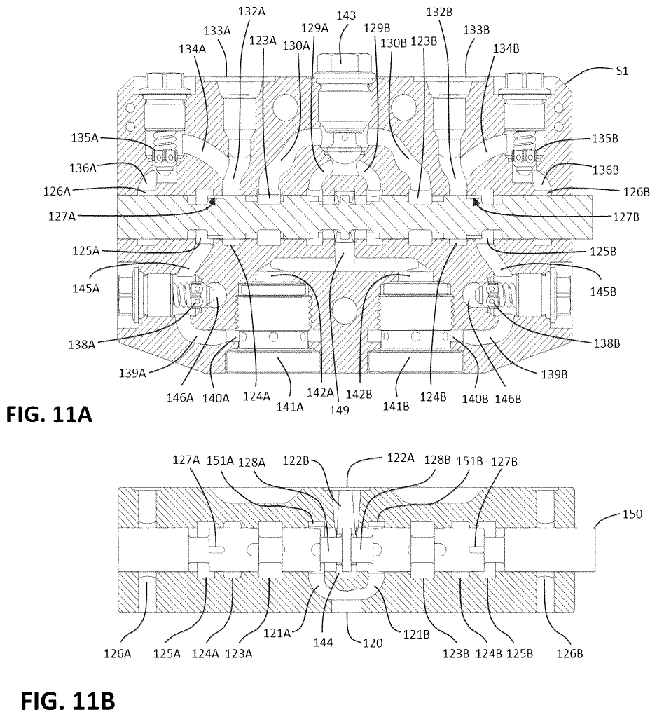

Section S1 may also include first and second port relief valves 153A and 153B, configured to relieve pressure from the first working passage 40A to tank passage 1B and from the second working passage 40B to tank passage 1C, respectively. These relief valves are optional and assist in interpreting FIGS. 11A and 11B.

FIGS. 11A and 11B illustrate a top and front cross-sectional view of the valve section S1, taken parallel to the flanging surface, as well as a plan view looking downward with the first spool 150 in a neutral state. The section S1 includes a first supply interface 120 in fluid communication with a first supply passage 121A leading to a first free flow connection port 151A and with a second supply passage 121B leading to a second free flow connection port 151B. The section S1 further includes an outlet supply interface 122A in fluid communication with a third free flow connection port 144 through a first free flow passage 122B. When the spool 150 is in the neutral state, fluid communication is maintained from the first and second free flow connection ports 151A and 151B to the third free flow connection port 144 through machined passages 128A and 128B formed within the valve body and spool geometry.

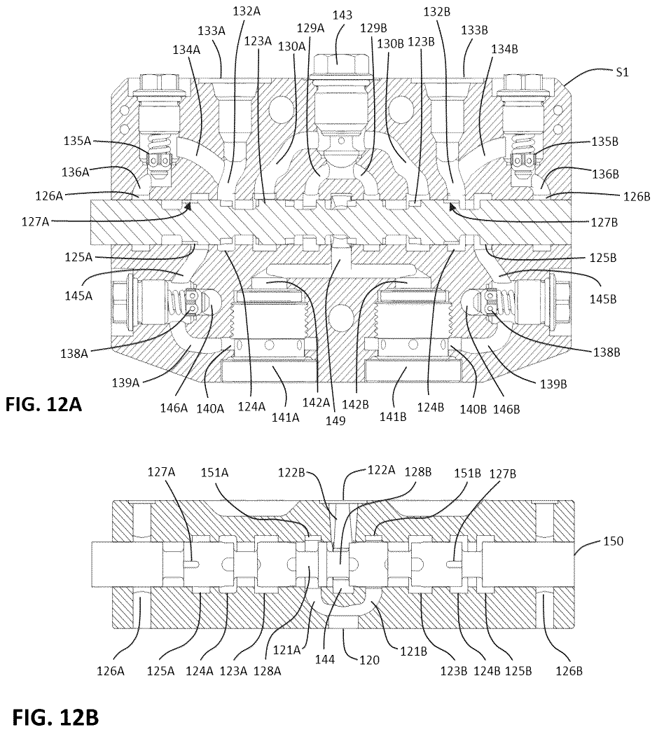

The section S1 additionally includes a first pressure supply connection port 123A coupled to a first pressure supply passage 130A and a second pressure supply connection port 123B coupled to a second pressure supply passage 130B. The first and second free flow connection ports 151A and 151B communicate with third and fourth supply passages 129A and 129B, respectively. A load check valve 143 is disposed between the supply passages 129A and 129B and the pressure supply passages 130A and 130B. The load check valve 143 is configured to permit fluid flow from the supply passages 129A and 129B to the pressure supply passages 130A and 130B when pressure at the supply passages exceeds a predetermined bias, and to prevent reverse flow from the pressure supply passages to the supply passages. This operation is further illustrated in the top and front cross-sectional views of FIGS. 12A and 12B when spool 150 is in its second operational state.

The section S1 includes a first working connection port 124A fluidly connected to a first work port 133A through a first working passage 132A, and a second working connection port 124B fluidly connected to a second work port 133B through a second working passage 132B. The spool 150 in the neutral state prevents fluid communication between the first pressure supply passage 130A and the first working connection port 124A, and likewise prevents fluid communication between the second pressure supply passage 130B and the second working connection port 124B. This functionality is accomplished by providing appropriate spool land overlap relative to the working connection ports 124A and 124B and the pressure supply ports 123A and 123B.

A first bypass connection port 125A is disposed within the section S1 and is fluidly coupled to a first bypass passage 145A. A first flow control element 138A is positioned within the first bypass passage 145A, resulting in the formation of a second bypass passage 139A in series with the first bypass passage. The section further includes a first tank passage 146A. The flow control element 138A is configured to regulate fluid communication between the first bypass passage 145A and the first tank passage 146A when pressure in the bypass passage exceeds a predetermined value. In some implementations, the flow control element 138A may be configured to meter or allow fluid flow in either direction depending on pressure conditions.

A second bypass connection port 125B is fluidly coupled to a third bypass passage 145B. A second flow control element 138B is disposed within the third bypass passage 145B, resulting in the formation of a fourth bypass passage 139B in series with the third bypass passage. The section S1 further includes a second tank passage 146B. The flow control element 138B regulates fluid flow between the third bypass passage 145B and the second tank passage 146B when pressure in the bypass passage exceeds a predetermined value, and may optionally meter flow in the reverse direction when tank pressure exceeds bypass pressure.

The section S1 also includes a first bypass check cavity housing a first bypass check valve 141A. The cavity is divided into a first bypass check inlet port 140A and a first bypass check outlet port 142A. The first bypass check valve 141A permits fluid flow from the inlet port 140A to the outlet port 142A and prevents reverse flow from the outlet port 142A to the inlet port 140A.

A second bypass check valve 141B is installed in a second bypass check cavity and divides the cavity into a second bypass check inlet port 140B and a second bypass check outlet port 142B. The second bypass check valve 141B permits fluid flow from the inlet port 140B to the outlet port 142B and prevents reverse flow from the outlet port 142B back to the inlet port 140B.

The section S1 includes a second free flow passage 149 formed to connect to either or both of the bypass check outlet ports 142A and 142B. The second free flow passage 149 provides direct fluid communication to the third free flow connection port 144, thereby routing bypass return flow toward downstream valve sections through the outlet supply interface 122A.

In some implementations, the section S1 further includes first and second work port pressure control valves 135A and 135B. Dedicated low pressure tank ports 126A and 126B may also be provided within the section. First and second work port branch passages 134A and 134B fluidly connect the work ports 133A and 133B to the cavities housing the work port pressure control valves 135A and 135B. First and second low pressure tank passages 136A and 136B fluidly connect the low-pressure tank ports 126A and 126B to the same cavities.

The work port pressure control valves 135A and 135B are configured to permit fluid flow from the corresponding work ports 133A and 133B to the corresponding low pressure tank ports 126A and 126B when the pressure at the work ports exceeds a predetermined setting. In certain configurations, reverse flow may be permitted when pressure at the work ports is lower than the pressure at the low-pressure tank ports.

The first and second work ports 133A and 133B are fluidly coupled to respective working connection ports 124A and 124B through the first and second working passages 132A and 132B.

The spool 150 is configured with a first bypass feature 127A providing fluid communication from the first working connection port 124A to the first bypass connection port 125A when the spool is in the neutral state. The spool 150 also includes a second bypass feature 127B providing fluid communication from the second work interface port 124B to the second bypass connection port 125B in the neutral state. These bypass features 127A and 127B are distinct machined flow paths, such as notches, spiral grooves, lateral grooves, or similar machined passages, and are not defined or formed by nominal spool to bore clearance and ensure a deliberate bypass path in neutral and in selected actuated positions.

FIGS. 12A and 12B illustrate the second operational state in which the spool 150 has been shifted to supply hydraulic fluid to the first work port 133A. In this state, the spool 150 blocks fluid communication from the first and second free flow connection ports 151A and 151B to the third free flow connection port 144. Fluid supplied to the supply passages 129A and 129B is directed through the load check valve 143 to the first pressure supply connection port 123A. A cutout in the spool 150 enables fluid communication from the first pressure supply connection port 123A to the first working connection port 124A, thereby supplying pressurized fluid to an actuator connected to the first work port 133A while the second working connection port 124B maintains bypass connectivity.

Return flow from the actuator is received at the second work port 133B and directed through the second working passage 132B to the second working connection port 124B. A cutout in the spool 150 permits return flow to pass from the second working connection port 124B to the second bypass connection port 125B. In this actuated state, the first bypass feature 127A no longer connects the first working connection port 124A to the first bypass connection port 125A, while the second bypass feature 127B maintains fluid communication between the second working connection port 124B and the second bypass connection port 125B ensuring continuity of bypass and series return flow even during upstream actuation.

Return flow continues from the second bypass connection port 125B through the third bypass passage 145B and into the second bypass check inlet port 140B. The second bypass check valve 141B directs flow to the second bypass check outlet port 142B, after which the flow enters the second free flow passage 149 and proceeds toward downstream functions via the outlet supply interface 122A. If a downstream function is stalled, pressure within the third bypass passage 145B increases. When this pressure exceeds the setting of the flow control element 138B, fluid is diverted to the second tank passage 146B, thereby preventing stalling of the actuator connected to section S1.

The first and second bypass features 127A and 127B are machined features intentionally incorporated into the spool 150. These features are not intended to be formed by nominal spool to bore clearance as found in conventional spool valve designs. Instead, they may consist of a notch, groove, spiral scratch, or other machined geometry configured to maintain the bypass connections described herein.

The embodiments described herein are not intended to be limited to a particular valve configuration, internal architecture, or number of valves. Connections referenced throughout this disclosure may define an interface between a spool and a cavity within a valve body and may represent the functional relationship between spool notches and internal passages. The fluidic paths between connections may include, but are not limited to, spool to cavity interfaces, machined flow paths, grooves, tubes, or other conduits formed within or external to the valve body. Flow control functionality described herein may be achieved using any suitable device, including pressure control valves, check valves, pilot operated valves, restrictors, orifices, compensators, or other flow regulating elements, and any such element may be placed within or external to the valve body. The bypass to free flow connections described may be implemented using one or more check valves, a common gallery, individual passages, merged passages, or direct passages without check valves, depending on the desired implementation.

Furthermore, the system is not limited to a single valve assembly and may be implemented using a plurality of valves connected together in a sectional or modular configuration. Alternatively, all control valves and internal flow paths may be integrated into a single valve body, such as a casting, manifold, or machined block. The control element within any valve may be a spool, poppet, rotary element, sliding plate, or any other device capable of selectively establishing fluid communication between passages or ports. Control of the valve or valves may be mechanical, hydraulic, pneumatic, electric, electrohydraulic, or a combination thereof. The various implementations described are intended to illustrate the flexibility of the system architecture and are not to be construed as limiting the scope of the present invention.

Referring to FIG. 1, a hydraulic valve V1 is configured to control multiple hydraulic actuators in a series-connected system. A tank 1A stores hydraulic fluid and is connected to a first tank passage 1B and a second tank passage 1C. A pump 10 delivers hydraulic fluid through a supply passage 10A to the hydraulic valve V1. A hydraulic boom cylinder 2A includes ports for receiving hydraulic fluid to control boom movement. A hydraulic bucket cylinder 3A includes ports for receiving hydraulic fluid to control bucket movement. An attachment actuator 4A provides hydraulic control for auxiliary attachments.

A first control valve 11 is operable among multiple states including a first state 11A0, a second state 11A1, and a third state 11A2. The first control valve 11 includes a first supply connection 11P fluidly connected to the supply passage 10A. A first working connection 50A is fluidly connected to a boom base port A1V through a first working passage 40A. A second working connection 50B is fluidly connected to a boom rod port B1V through a second working passage 40B. The boom base port A1V and boom rod port B1V connect to corresponding ports of the hydraulic boom cylinder 2A.

A first bypass connection 20 is fluidly connected to a first bypass passage 30, which provides fluid communication to the tank 1A via the first tank passage 1B. A second free flow connection 60 is fluidly connected to a first free flow passage 60A, enabling fluid communication to downstream components. In the first state 11A0, the first working connection 50A and second working connection 50B are both fluidly connected to the first bypass connection 20, allowing return flow from the hydraulic boom cylinder 2A to be directed to the tank 1A through the first bypass passage 30.

A second control valve 12 is disposed downstream of the first control valve 11 and is operable among a second neutral state 12A0, a fourth state 12A1, and a fifth state 12A2. The second control valve 12 includes a second supply connection 12P and a second bypass connection 21 fluidly connected to a second bypass passage 31. A third working connection 50C is fluidly connected to a bucket base port A2V through a third working passage 40C. A fourth working connection 50D is fluidly connected to a bucket rod port B2V through a fourth working passage 40D. The bucket base port A2V and bucket rod port B2V connect to corresponding ports of the hydraulic bucket cylinder 3A. A fourth free flow connection 61 provides fluid communication to further downstream components.

A third control valve 13 is disposed downstream of the second control valve 12 and is configured to control the attachment actuator 4A. The attachment actuator 4A includes a first attachment port A3V and a second attachment port B3V, which connect to corresponding ports A3A and B3A of the attachment actuator 4A. The configuration allows simultaneous operation of multiple actuators while maintaining a bypass path to the tank 1A, preventing stalling of upstream actuators when downstream actuators reach the end of their stroke.

Referring to FIG. 2, a hydraulic valve V2 comprises three control valves arranged to manage fluid flow from the pump 10 to various actuators and back to the tank 1A. The first control valve 11 includes a first control element 11A and a first free flow connection 11F that receives fluid from the supply passage 10A. A distinguishing feature of this embodiment is the split bypass configuration where the first control valve 11 includes a first bypass connection 20A and a second bypass connection 20B. The first bypass connection 20A is fluidly connected to a first bypass passage 30A, which routes fluid to the tank 1A via the first tank passage 1B. The second bypass connection 20B is fluidly connected to a second bypass passage 30B, which routes fluid to the tank 1A via the second tank passage 1C.

The second control valve 12 includes a third bypass connection 20C and a fourth bypass connection 20D. The third bypass connection 20C is connected to a third bypass passage 30C, and the fourth bypass connection 20D is connected to a fourth bypass passage 30D, both routing fluid to the tank 1A. The circuit configuration allows for series operation where return flow from an upstream actuator can be directed to a downstream actuator while maintaining a bypass path to the tank 1A.

With continued reference to FIG. 2, when the first control valve 11 is in the first state 11A0, the first working connection 50A is fluidly connected to the first bypass connection 20A, and the second working connection 50B is fluidly connected to the second bypass connection 20B. When the first control valve 11 transitions to the second state 11A1, the connection between the first working connection 50A and the first bypass connection 20A is partially or completely closed, while the second working connection 50B remains connected to the second bypass connection 20B and also establishes a connection with the second free flow connection 60.

Referring to FIG. 3, a hydraulic valve V3 includes a bypass system configured with four separate bypass passages associated with the first control valve 11. The first bypass connection 20A is fluidly connected to the first bypass passage 30A and a second bypass passage 30A1, both of which route fluid to the first tank passage 1B. The second bypass connection 20B is fluidly connected to the third bypass passage 30B and a fourth bypass passage 30B1, both of which route fluid to the second tank passage 1C. This configuration provides redundant bypass paths for each working connection.

The second control valve 12 receives fluid through a third free flow connection 12F, which is fluidly connected to the second free flow connection 60. The second control valve 12 includes a third working connection 12C and a fourth working connection 12D for controlling hydraulic actuators. The provision of multiple parallel bypass passages, including the first bypass passage 30A and second bypass passage 30A1 for the first working connection, and the third bypass passage 30B and fourth bypass passage 30B1 for the second working connection, provides redundant flow paths that enhance system reliability.

Referring to FIG. 4, restrictions are incorporated within the bypass connections to control flow characteristics. A first restriction 70A is disposed within the connection between the first working connection 50A and the first bypass connection 20A. A second restriction 70B is disposed within the connection between the second working connection 50B and the second bypass connection 20B. Similarly, a third restriction 70C is disposed within the connection between the third working connection 50C and the third bypass connection 20C, and a fourth restriction 70D is disposed within the connection between the fourth working connection 50D and the fourth bypass connection 20D. The restrictions 70A, 70B, 70C, and 70D are configured to limit flow from the respective working connections to the tank passages without impeding flow from the working connections to the free flow connections.

As shown in FIG. 5, restrictions are disposed directly within the bypass passages to limit hydraulic fluid flow. A first restriction 90A is disposed within the first bypass passage 30A between the first bypass connection 20A and the first tank passage 1B. A second restriction 90B is disposed within the second bypass passage 30B between the second bypass connection 20B and the second tank passage 1C. A third restriction 90C is disposed within the third bypass passage 30C between the third bypass connection 20C and the second tank passage 1C. A fourth restriction 90D is disposed within the fourth bypass passage 30D between the fourth bypass connection 20D and the first tank passage 1B. The restrictions 90A, 90B, 90C, and 90D limit the flow of hydraulic fluid through the respective bypass passages to the tank 1A while allowing controlled bypass flow without impeding the series flow path.

Referring to FIG. 6, pressure control valves are incorporated within the bypass passages to provide pressure-responsive flow control. A first pressure control valve 100A is disposed within the first bypass passage 30A, and a second pressure control valve 100B is disposed within the second bypass passage 30B. A third pressure control valve 100C is disposed within the third bypass passage 30C, and a fourth pressure control valve 100D is disposed within the fourth bypass passage 30D. The pressure control valves 100A, 100B, 100C, and 100D regulate flow from their respective bypass connections to the tank passages based on predetermined pressure thresholds. Multiple pressure control valves are disposed in each bypass allowing for a stepped response to a rise in system pressure or load so that higher pressure stages progressively open additional bypass capacity as needed.

As further shown in FIG. 6, when a downstream actuator stalls during multifunction operation, the pressure control valves open to allow return flow from an upstream actuator to bypass to the tank, preventing stalling of the upstream function. An orifice is disposed in parallel with a pressure control valve to provide a response that is clipped when a given pressure in the series channel is achieved allowing a controlled blend of fixed-orifice flow and pressure-responsive flow regulation.

Referring to FIG. 7, pilot operated check valves are incorporated within the working passages to provide controlled flow direction. A first pilot operated check valve 80A is disposed within the first working passage 40A, and a second pilot operated check valve 80B is disposed within the second working passage 40B. A third pilot operated check valve 80C is disposed within the third working passage 40C, and a fourth pilot operated check valve 80D is disposed within the fourth working passage 40D. A first pilot line 81A connects from the second working passage 40B to the first pilot operated check valve 80A. A second pilot line 81B connects from the first working passage 40A to the second pilot operated check valve 80B. A third pilot line 81C connects from the fourth working passage 40D to the third pilot operated check valve 80C. A fourth pilot line 81D connects from the third working passage 40C to the fourth pilot operated check valve 80D.

With continued reference to FIG. 7, the pilot operated check valves 80A, 80B, 80C, and 80D are configured to prevent flow in one direction when unpiloted and to permit flow in both directions when piloted by pressure from the corresponding pilot lines 81A, 81B, 81C, and 81D. The pilot operated check valves are alternatively implemented using counterbalance valves, pilot operated sequence valves, or other pressure responsive or pilot actuated valve types. A tank 1 provides hydraulic fluid storage, and a second supply connection 12B supplies pressurized fluid to the second control valve 12.

Referring to FIG. 8, a check valve 110 is disposed within a free flow passage 111 between the second free flow connection 60 of the first control valve 11 and the third free flow connection 12F of the second control valve 12. The check valve 110 prevents reverse flow from the third free flow connection 12F back to the second free flow connection 60, thereby maintaining controlled flow direction within the series circuit and preventing unintended back feeding between valve sections.

As shown in FIG. 10, a valve section S1 is configured for modular assembly where multiple sections can be flanged together. The valve section S1 includes a supply interface 155A that receives pressurized hydraulic fluid and an outlet supply interface 155B that provides fluid communication to downstream valve sections. A first inlet tank interface 154A and a second inlet tank interface 154C connect to upstream tank passages, while a first outlet tank interface 154B and a second outlet tank interface 154D connect to downstream tank passages. A first port relief valve 153A and a second port relief valve 153B provide pressure relief for the working passages.

The valve section S1 includes a first free flow bypass passage 112A and a second free flow bypass passage 112B that connect bypass passages to free flow connections. A first drain passage 113A connects to a first flow control element 114, and a second drain passage 113B connects to a second flow control element 115. A first bypass check valve 117 is disposed in the first free flow bypass passage 112A, and a second bypass check valve 116 is disposed in the second free flow bypass passage 112B. A third free flow bypass passage 118 and a fourth free flow bypass passage 119 provide additional flow routing capabilities.

Referring to FIGS. 11A and 11B, the valve section S1 includes internal components arranged for controlled fluid flow. A first supply interface 120 receives pressurized fluid and directs the fluid through a first supply passage 121A and a second supply passage 121B to a first free flow connection port 151A and a second free flow connection port 151B, respectively. An outlet supply interface 122A provides fluid communication through a first free flow passage 122B to a third free flow connection port 144. A first pressure supply connection port 123A and a second pressure supply connection port 123B are coupled to a first pressure supply passage 130A and a second pressure supply passage 130B, respectively.

A spool 150 is positioned within the valve section S1 and includes a first bypass feature 127A and a second bypass feature 127B. The bypass features consist of a notch, groove, spiral scratch, or other machined geometry configured to maintain the bypass connections and are distinct from nominal spool to bore clearance. A first working connection port 124A is fluidly connected to a first work port 133A via a first working passage 132A. A second working connection port 124B is fluidly connected to a second work port 133B via a second working passage 132B.

With continued reference to FIGS. 11A and 11B, a first bypass connection port 125A is connected to a first bypass passage 145A, and a second bypass connection port 125B is connected to a third bypass passage 145B. A first low pressure tank port 126A and a second low pressure tank port 126B provide low pressure tank connections. A first machined passage 128A and a second machined passage 128B facilitate fluid communication between connection ports depending on spool position. A third supply passage 129A and a fourth supply passage 129B connect to the first and second free flow connection ports 151A and 151B.

A load check valve 143 is disposed between the third and fourth supply passages 129A and 129B and the first and second pressure supply passages 130A and 130B. A first work port branch passage 134A and a second work port branch passage 134B connect the first and second work ports 133A and 133B to a first work port pressure control valve 135A and a second work port pressure control valve 135B, respectively. A first low pressure tank passage 136A and a second low pressure tank passage 136B connect the low pressure tank ports to the work port pressure control valves.

Referring to FIGS. 12A and 12B, the valve section S1 is shown in a second operational state where the spool 150 has been shifted to supply hydraulic fluid to the first work port 133A. A first flow control element 138A is disposed in the first bypass passage 145A, creating a second bypass passage 139A downstream of the element. A second flow control element 138B is disposed in the third bypass passage 145B, creating a fourth bypass passage 139B downstream of the element. The first and second flow control elements 138A and 138B regulate flow to a first tank passage 146A and a second tank passage 146B, respectively.

A first bypass check inlet port 140A and a second bypass check inlet port 140B receive fluid from the bypass passages. A first bypass check valve 141A is positioned between the first bypass check inlet port 140A and a first bypass check outlet port 142A. A second bypass check valve 141B is positioned between the second bypass check inlet port 140B and a second bypass check outlet port 142B. The first and second bypass check outlet ports 142A and 142B are fluidly connected to the third free flow connection port 144 through a second free flow passage 149.

Flow control functionality is achieved using any suitable device, including pressure control valves, check valves, pilot operated valves, restrictors, orifices, compensators, or other flow regulating elements, and any such element is placed within or external to the valve body. The bypass to free flow connections are implemented using one or more check valves, a common gallery, individual passages, merged passages, or direct passages without check valves, depending on the desired implementation. The control element within any valve is a spool, poppet, rotary element, sliding plate, or any other device capable of selectively establishing fluid communication between passages or ports.

Control of the valve or valves is mechanical, hydraulic, pneumatic, electric, electrohydraulic, or a combination thereof. The system comprises a plurality of valves fluidly connected to one another, or all control valves and internal flow paths are integrated into a single valve body, such as a casting, manifold, or machined block. An electronically controlled valve is placed in the bypass allowing for oil to flow to tank when an electronic signal is provided to the valve. An electronically controlled valve is disposed in any of the four working passages and is commandable in the neutral, second, or third state of the control valve, or independently in response to an operator input or control signal. Each of the four bypasses include a restriction providing a redundant operation in the case that one orifice is plugged with contamination and operation when the orifices are not plugged.

Referring to FIG. 1, a hydraulic system HS is configured to control multiple hydraulic actuators in a series-connected arrangement. The hydraulic system HS includes the tank 1A configured to store hydraulic fluid, with the tank 1A fluidly connected to the first tank passage 1B and the second tank passage 1C for hydraulic fluid return. The pump 10 is operable to deliver pressurized hydraulic fluid through the supply passage 10A to the hydraulic valve V1. The hydraulic valve V1 comprises three control valves arranged in series to manage fluid flow to various actuators and back to the tank 1A.

The hydraulic boom cylinder 2A includes a boom base port A1A and a boom rod port B1A for receiving hydraulic fluid to control boom movement in respective directions. The hydraulic bucket cylinder 3A includes a bucket base port A2A and a bucket rod port B2A for receiving hydraulic fluid to control bucket movement. The attachment actuator 4A includes a first attachment port A3A and a second attachment port B3A for receiving hydraulic fluid to operate auxiliary attachments or implements.

The first control valve 11 is disposed within the hydraulic valve V1 and is operable among multiple states including the first state 11A0, the second state 11A1, and the third state 11A2. The first control valve 11 includes the first supply connection 11P fluidly connected to the supply passage 10A to receive pressurized fluid from the pump 10. The first working connection 50A is fluidly connected to the boom base port A1V through the first working passage 40A, enabling fluid communication between the first control valve 11 and the boom base port A1A of the hydraulic boom cylinder 2A. The second working connection 50B is fluidly connected to the boom rod port B1V through the second working passage 40B, enabling fluid communication between the first control valve 11 and the boom rod port B1A of the hydraulic boom cylinder 2A.

The first bypass connection 20 is fluidly connected to the first bypass passage 30, which provides fluid communication to the tank 1A via the first tank passage 1B. The second free flow connection 60 is fluidly connected to the first free flow passage 60A, enabling fluid communication to downstream components within the series circuit. In the first state 11A0, the first working connection 50A and the second working connection 50B are both fluidly connected to the first bypass connection 20, allowing return flow from the hydraulic boom cylinder 2A to be directed to the tank 1A through the first bypass passage 30 and the first tank passage 1B.

When the first control valve 11 transitions to the second state 11A1, the connection between the first working connection 50A and the first bypass connection 20 is partially or completely eliminated. A fluidic connection is established between the first working connection 50A and the first supply connection 11P, allowing hydraulic fluid from the pump 10 to be delivered to the boom base port A1V through the first working passage 40A, resulting in extension of the hydraulic boom cylinder 2A. Simultaneously, the connection between the second working connection 50B and the first bypass connection 20 remains intact while a connection is also established between the second working connection 50B and the second free flow connection 60, enabling return flow from the boom rod port B1A to be directed both to the tank 1A and to downstream valve sections.

When the first control valve 11 transitions to the third state 11A2, the connection between the second working connection 50B and the first bypass connection 20 is partially or completely eliminated. A fluidic connection is established between the second working connection 50B and the first supply connection 11P, allowing hydraulic fluid from the pump 10 to be delivered to the boom rod port B1V through the second working passage 40B, resulting in retraction of the hydraulic boom cylinder 2A. The connection between the first working connection 50A and the first bypass connection 20 remains intact while a connection is also established between the first working connection 50A and the second free flow connection 60, enabling return flow from the boom base port A1A to be directed both to the tank 1A and to downstream valve sections.

The second control valve 12 is disposed downstream of the first control valve 11 within the hydraulic valve V1 and receives fluid through the first free flow passage 60A. The second control valve 12 is operable among the second neutral state 12A0, the fourth state 12A1, and the fifth state 12A2. The second control valve 12 includes the second supply connection 12P for receiving pressurized fluid and the second bypass connection 21 fluidly connected to the second bypass passage 31. The third working connection 50C is fluidly connected to the bucket base port A2V through the third working passage 40C, enabling fluid communication with the bucket base port A2A of the hydraulic bucket cylinder 3A. The fourth working connection 50D is fluidly connected to the bucket rod port B2V through the fourth working passage 40D, enabling fluid communication with the bucket rod port B2A of the hydraulic bucket cylinder 3A.

The fourth free flow connection 61 provides fluid communication from the second control valve 12 to further downstream components within the series circuit. The second control valve 12 operates in a manner similar to the first control valve 11, with bypass connectivity maintained to at least one working connection across the various valve states to enable continued series operation and prevent stalling of upstream actuators during multifunction operation.

The third control valve 13 is disposed downstream of the second control valve 12 within the hydraulic valve V1 and receives fluid through the fourth free flow connection 61. The third control valve 13 is configured to control the attachment actuator 4A through connections to the first attachment port A3V and the second attachment port B3V, which correspond to the first attachment port A3A and the second attachment port B3A of the attachment actuator 4A. The series flow path is established through the first free flow passage 60A connecting the first control valve 11 to the second control valve 12, and through subsequent free flow connections that enable hydraulic fluid to flow sequentially through each valve section while maintaining bypass paths to the tank 1A through the first tank passage 1B and the second tank passage 1C.

The hydraulic valve V2 incorporates a split bypass configuration that divides bypass functionality between separate flow paths to enhance system performance and reliability. The first control valve 11 includes the first control element 11A positioned to selectively establish fluid communication between various connections within the valve. The first free flow connection 11F receives pressurized hydraulic fluid from the supply passage 10A and directs the fluid through the first control valve 11 when in neutral position. The first supply connection 11P provides pressurized fluid to actuator circuits when the first control valve 11 is shifted from neutral to an actuated state.

The split bypass arrangement replaces a single bypass connection with the first bypass connection 20A and the second bypass connection 20B, each serving a dedicated working connection. The first bypass connection 20A is fluidly connected to the first bypass passage 30A, which provides a dedicated flow path to the tank 1A through the first tank passage 1B. The second bypass connection 20B is fluidly connected to the second bypass passage 30B, which provides a separate dedicated flow path to the tank 1A through the second tank passage 1C. This configuration establishes independent bypass paths for each working connection, allowing selective bypass control based on valve position and operational requirements.

With continued reference to FIG. 2, the first working connection 50A maintains fluid communication with the first bypass connection 20A through the first bypass passage 30A when the first control valve 11 is in the first state 11A0 or the third state 11A2. The second working connection 50B maintains fluid communication with the second bypass connection 20B through the second bypass passage 30B when the first control valve 11 is in the first state 11A0 or the second state 11A1. The split bypass configuration ensures that at least one working connection retains bypass connectivity across all valve positions, preventing complete isolation of return flow paths during actuator operation.

The second control valve 12 incorporates a similar split bypass arrangement with the third bypass connection 20C connected to the third bypass passage 30C and the fourth bypass connection 20D connected to the fourth bypass passage 30D. The third bypass connection 20C provides bypass flow to the first tank passage 1B, while the fourth bypass connection 20D provides bypass flow to the second tank passage 1C. The second control valve 12 operates through the same principles as the first control valve 11, maintaining bypass connectivity to at least one working connection while enabling series flow through the fourth free flow connection 61 to the third control valve 13.

Series operation is maintained through the second free flow connection 60 of the first control valve 11, which connects to downstream valve sections through the first free flow passage 60A. When the first control valve 11 transitions from the first state 11A0 to the second state 11A1, return flow from the second working connection 50B is directed simultaneously through the second bypass passage 30B to the tank 1A and through the second free flow connection 60 to the second control valve 12. This dual flow path arrangement allows upstream actuator operation to continue even when downstream actuators become stalled, as the bypass passages provide alternative flow routing while series connectivity is maintained through the free flow connections.

The split bypass configuration provides enhanced flow management capabilities by establishing separate tank return paths through the first tank passage 1B and the second tank passage 1C. The first bypass passage 30A and the third bypass passage 30C route fluid to the first tank passage 1B, while the second bypass passage 30B and the fourth bypass passage 30D route fluid to the second tank passage 1C. This arrangement distributes return flow across multiple tank connections, reducing flow restrictions and improving system response during multifunction operation when multiple actuators operate simultaneously.

Referring to FIG. 3, the hydraulic valve V3 incorporates a multiple parallel bypass passage configuration that provides enhanced redundancy and operational reliability through the implementation of four separate bypass passages. The first bypass connection 20A is fluidly connected to both the first bypass passage 30A and the second bypass passage 30A1, establishing dual flow paths from the first working connection 50A to the first tank passage 1B. The second bypass connection 20B is fluidly connected to both the third bypass passage 30B and the fourth bypass passage 30B1, establishing dual flow paths from the second working connection 50B to the second tank passage 1C.

The multiple parallel bypass arrangement provides redundant bypass paths for each working connection within the first control valve 11. When the first control valve 11 operates in the first state 11A0, both the first working connection 50A and the second working connection 50B maintain fluid communication with their respective bypass connections through the parallel bypass passages. The first working connection 50A directs return flow through both the first bypass passage 30A and the second bypass passage 30A1 to the first tank passage 1B, while the second working connection 50B directs return flow through both the third bypass passage 30B and the fourth bypass passage 30B1 to the second tank passage 1C.

With continued reference to FIG. 3, when the first control valve 11 transitions to the second state 11A1, the first working connection 50A is disconnected from the first bypass connection 20A, eliminating flow through both the first bypass passage 30A and the second bypass passage 30A1. The second working connection 50B maintains connectivity to the second bypass connection 20B, preserving flow through both the third bypass passage 30B and the fourth bypass passage 30B1 while simultaneously establishing connection to the second free flow connection 60 for series operation. When the first control valve 11 transitions to the third state 11A2, the configuration reverses, with the second working connection 50B disconnected from the second bypass connection 20B while the first working connection 50A maintains connectivity through both the first bypass passage 30A and the second bypass passage 30A1.

The second control valve 12 incorporates a similar multiple parallel bypass configuration where the third working connection 50C and the fourth working connection 50D are each served by redundant bypass paths. The third working connection 50C connects to bypass passages that route fluid to the tank passages, while the fourth working connection 50D connects to separate bypass passages that provide alternative routing to the tank passages. The second control valve 12 maintains bypass connectivity through multiple parallel passages across all valve states while directing flow to downstream components through the third free flow connection 12F and the fourth free flow connection 61.

Each of the four bypass passages includes a restriction that provides redundant operation in the case that one orifice is plugged with contamination and operation when the orifices are not plugged. The restrictions within the first bypass passage 30A and the second bypass passage 30A1 operate in parallel to control flow from the first working connection 50A to the first tank passage 1B. The restrictions within the third bypass passage 30B and the fourth bypass passage 30B1 operate in parallel to control flow from the second working connection 50B to the second tank passage 1C. When one restriction becomes blocked due to contamination, the parallel restriction continues to provide bypass flow capability, ensuring continued system operation and preventing complete loss of bypass functionality.

The parallel bypass restrictions provide operational reliability by maintaining flow capacity even when individual orifices experience blockage. When both restrictions in a parallel pair remain unobstructed, the combined flow capacity provides enhanced bypass performance during high flow conditions or when rapid pressure relief is required. The redundant restriction arrangement ensures that bypass connectivity remains available across neutral and actuated valve positions, supporting continued upstream actuator motion even when downstream actuators become stalled during multifunction operation.

The multiple parallel bypass passage configuration distributes return flow across separate tank connections through the first tank passage 1B and the second tank passage 1C. The first bypass passage 30A and the second bypass passage 30A1 direct fluid from the first working connection 50A to the first tank passage 1B, while the third bypass passage 30B and the fourth bypass passage 30B1 direct fluid from the second working connection 50B to the second tank passage 1C. This arrangement provides multiple independent flow paths that enhance system reliability and maintain bypass functionality even when individual passages experience flow restrictions or component failures.

Referring to FIG. 4, restrictions are strategically positioned between working connections and bypass connections to provide controlled flow limitation within the hydraulic circuit. The first restriction 70A is disposed between the first working connection 50A and the first bypass connection 20A, establishing a controlled flow path that limits hydraulic fluid flow from the first working connection 50A to the first bypass passage 30A. The second restriction 70B is disposed between the second working connection 50B and the second bypass connection 20B, providing controlled flow limitation from the second working connection 50B to the second bypass passage 30B. The third restriction 70C is disposed between the third working connection 50C and the third bypass connection 20C, controlling flow from the third working connection 50C to the third bypass passage 30C. The fourth restriction 70D is disposed between the fourth working connection 50D and the fourth bypass connection 20D, regulating flow from the fourth working connection 50D to the fourth bypass passage 30D.

The restrictions 70A, 70B, 70C, and 70D are configured to limit flow from the respective working connections to the tank passages without impeding flow from the working connections to the free flow connections. When the first control valve 11 operates in the first state 11A0, both the first restriction 70A and the second restriction 70B control bypass flow to the first tank passage 1B and the second tank passage 1C respectively, while maintaining open communication between the first free flow connection 11F and the second free flow connection 60. When the first control valve 11 transitions to the second state 11A1, the first restriction 70A becomes inactive as the connection between the first working connection 50A and the first bypass connection 20A is closed, while the second restriction 70B continues to regulate bypass flow from the second working connection 50B while simultaneously allowing unrestricted flow to the second free flow connection 60.

With continued reference to FIG. 4, when the first control valve 11 operates in the third state 11A2, the second restriction 70B becomes inactive as the connection between the second working connection 50B and the second bypass connection 20B is closed, while the first restriction 70A regulates bypass flow from the first working connection 50A while allowing unrestricted series flow to the second free flow connection 60. The second control valve 12 operates through the same restriction principles, with the third restriction 70C and the fourth restriction 70D controlling bypass flow during the fourth state 12A1 and the fifth state 12A2 respectively, ensuring that bypass connectivity remains available to at least one working connection across all valve positions.

Referring to FIG. 5, restrictions are positioned directly within the bypass passages to provide controlled flow limitation between bypass connections and tank passages. The first restriction 90A is disposed within the first bypass passage 30A between the first bypass connection 20A and the first tank passage 1B, establishing a controlled flow path that limits hydraulic fluid flow from the first bypass connection 20A to the tank 1A. The second restriction 90B is disposed within the second bypass passage 30B between the second bypass connection 20B and the second tank passage 1C, controlling flow from the second bypass connection 20B to the tank 1A. The third restriction 90C is disposed within the third bypass passage 30C between the third bypass connection 20C and the second tank passage 1C, regulating flow from the third bypass connection 20C to the tank 1A. The fourth restriction 90D is disposed within the fourth bypass passage 30D between the fourth bypass connection 20D and the first tank passage 1B, limiting flow from the fourth bypass connection 20D to the tank 1A.

The restrictions 90A, 90B, 90C, and 90D provide controlled limitation of hydraulic fluid flow through the bypass passages to the tank 1A across all operational states of the first control valve 11 and the second control valve 12. When the first control valve 11 operates in the first state 11A0, both the first restriction 90A and the second restriction 90B regulate bypass flow from the first working connection 50A and the second working connection 50B respectively, maintaining controlled flow rates to the first tank passage 1B and the second tank passage 1C while preserving series flow capability through the second free flow connection 60. The restrictions ensure that bypass flow remains controlled and predictable regardless of valve position, preventing excessive flow rates that could interfere with system operation or create pressure imbalances within the hydraulic circuit.

As further shown in FIG. 5, when the first control valve 11 transitions to the second state 11A1, the second restriction 90B continues to regulate bypass flow from the second working connection 50B through the second bypass passage 30B to the second tank passage 1C, while simultaneously allowing unrestricted series flow through the second free flow connection 60 to downstream valve sections. When the first control valve 11 operates in the third state 11A2, the first restriction 90A regulates bypass flow from the first working connection 50A through the first bypass passage 30A to the first tank passage 1B, while maintaining unrestricted series flow capability. The controlled bypass flow limitation provided by the restrictions 90A, 90B, 90C, and 90D ensures that return flow from actuators is directed to the tank 1A at controlled rates while preserving the ability to direct flow to downstream components through the free flow connections, enabling continued upstream actuator motion even when downstream actuators become stalled during multifunction operation.

Referring to FIG. 6, pressure control valves are strategically positioned within bypass passages to provide pressure-responsive flow regulation that addresses stalling conditions during multifunction hydraulic operation. The first pressure control valve 100A is disposed within the first bypass passage 30A between the first bypass connection 20A and the first tank passage 1B, establishing a pressure-controlled flow path from the first working connection 50A to the tank 1A. The second pressure control valve 100B is disposed within the second bypass passage 30B between the second bypass connection 20B and the second tank passage 1C, providing pressure-responsive control of flow from the second working connection 50B to the tank 1A. The third pressure control valve 100C is disposed within the third bypass passage 30C between the third bypass connection 20C and the first tank passage 1B, regulating pressure-controlled flow from the third working connection 50C. The fourth pressure control valve 100D is disposed within the fourth bypass passage 30D between the fourth bypass connection 20D and the second tank passage 1C, controlling pressure-responsive flow from the fourth working connection 50D.

The pressure control valves 100A, 100B, 100C, and 100D operate based on predetermined pressure thresholds that correspond to system conditions encountered during multifunction operation. When the first control valve 11 operates in the second state 11A1 and the second control valve 12 operates in the fourth state 12A1, return flow from the first working connection 50A is directed through the second free flow connection 60 to the third free flow connection 12F of the second control valve 12. When a downstream actuator connected to the second control valve 12 reaches the end of its stroke or becomes stalled, pressure builds within the series flow path, creating backpressure that is communicated through the second working connection 50B to the second bypass connection 20B and the second bypass passage 30B.

As further shown in FIG. 6, when the pressure within the second bypass passage 30B exceeds the predetermined threshold of the second pressure control valve 100B, the valve opens to allow return flow from the second working connection 50B to bypass directly to the tank 1A through the second tank passage 1C. This pressure-responsive bypass operation prevents stalling of the upstream actuator by providing an alternative flow path while maintaining series flow capability through the first free flow connection 11F, the second free flow connection 60, the third free flow connection 12F, and the fourth free flow connection 61. The first pressure control valve 100A operates through the same pressure-responsive principles when the first control valve 11 operates in the third state 11A2, opening when pressure within the first bypass passage 30A exceeds its predetermined threshold to allow bypass flow from the first working connection 50A to the tank 1A through the first tank passage 1B.

Multiple pressure control valves are disposed in each bypass passage to provide a stepped response to rising system pressure or load conditions. A first stage pressure control valve opens at a lower pressure threshold to provide initial bypass capacity, while a second stage pressure control valve opens at a higher pressure threshold to provide additional bypass capacity when system pressures continue to rise. Higher pressure stages progressively open additional bypass capacity as needed, creating a graduated pressure response that matches bypass flow capacity to system demand. The stepped pressure response prevents excessive pressure buildup while providing controlled bypass flow that maintains system stability during varying load conditions.

With continued reference to FIG. 6, an orifice is disposed in parallel with each pressure control valve to provide a controlled blend of fixed-orifice flow and pressure-responsive flow regulation. The parallel orifice configuration allows a predetermined amount of bypass flow to occur continuously through the fixed orifice, while the pressure control valve provides additional flow capacity when pressure thresholds are exceeded. The response is clipped when a given pressure in the series channel is achieved, as the pressure control valve opens to provide unrestricted flow while the parallel orifice continues to provide its fixed flow contribution. This arrangement ensures that bypass flow is available at all operating pressures while providing enhanced flow capacity during high pressure conditions that occur when downstream actuators become stalled.

An electronically controlled valve is placed within the bypass passages to provide electronic control of bypass flow independent of pressure conditions. The electronically controlled valve allows hydraulic fluid to flow to the tank 1A when an electronic signal is provided to the valve, enabling operator-controlled or system-controlled bypass operation. The electronic signal is selectable by the operator through manual controls or is triggered automatically by system events such as a multifunction command in which more than one control valve is commanded simultaneously. The electronically controlled valve provides bypass flow control that supplements or overrides the pressure-responsive operation of the pressure control valves 100A, 100B, 100C, and 100D, allowing system optimization based on operational requirements or operator preferences.

Flow control functionality within the bypass passages is achieved using various flow regulating devices that provide different operational characteristics based on system requirements. Pressure control valves provide pressure-responsive flow regulation that opens bypass paths when predetermined pressure thresholds are exceeded. Check valves provide unidirectional flow control that prevents reverse flow within bypass passages while allowing forward flow to the tank passages. Pilot operated valves provide externally controlled flow regulation that responds to pilot pressure signals from other system locations. Restrictors provide fixed flow limitation that controls bypass flow rates across all operating conditions. Orifices provide calibrated flow openings that establish predetermined flow rates based on pressure differentials. Compensators provide pressure-compensated flow regulation that maintains consistent flow rates despite varying pressure conditions. Other flow regulating elements include sequence valves, relief valves, and proportional valves that provide specialized flow control characteristics based on specific system requirements.

Referring to FIG. 7, pilot operated check valves are incorporated within the working passages to provide controlled flow direction and prevent unintended actuator movement when control valves are in neutral positions. The first pilot operated check valve 80A is disposed within the first working passage 40A between the first working connection 50A and the boom base port A1V. The second pilot operated check valve 80B is disposed within the second working passage 40B between the second working connection 50B and the boom rod port B1V. The third pilot operated check valve 80C is disposed within the third working passage 40C between the third working connection 50C and the bucket base port A2V. The fourth pilot operated check valve 80D is disposed within the fourth working passage 40D between the fourth working connection 50D and the bucket rod port B2V.

The first pilot line 81A connects from the second working passage 40B to the first pilot operated check valve 80A, providing hydraulic pilot pressure to control valve operation. The second pilot line 81B connects from the first working passage 40A to the second pilot operated check valve 80B, establishing pilot control communication between opposite working passages. The third pilot line 81C connects from the fourth working passage 40D to the third pilot operated check valve 80C, enabling pilot actuation of the third pilot operated check valve 80C. The fourth pilot line 81D connects from the third working passage 40C to the fourth pilot operated check valve 80D, providing pilot pressure communication for valve control.

With continued reference to FIG. 7, when the first control valve 11 is in the first state 11A0, the first pilot operated check valve 80A and the second pilot operated check valve 80B prevent flow from the boom base port A1V and the boom rod port B1V respectively to their corresponding working connections. The pilot operated check valves remain closed in the absence of pilot pressure, preventing unintended actuator movement and maintaining actuator position when the first control valve 11 is in neutral. When the first control valve 11 transitions to the second state 11A1, pressurized fluid is delivered to the first working connection 50A and through the first working passage 40A, creating pilot pressure that is communicated through the second pilot line 81B to open the second pilot operated check valve 80B. The opened second pilot operated check valve 80B permits return flow from the boom rod port B1V through the second working passage 40B to the second working connection 50B.

When the first control valve 11 transitions to the third state 11A2, pressurized fluid is delivered to the second working connection 50B and through the second working passage 40B, creating pilot pressure that is communicated through the first pilot line 81A to open the first pilot operated check valve 80A. The opened first pilot operated check valve 80A permits return flow from the boom base port A1V through the first working passage 40A to the first working connection 50A. The second control valve 12 operates through the same pilot control principles, with the third pilot operated check valve 80C and the fourth pilot operated check valve 80D providing controlled flow direction based on pilot pressure signals from opposite working passages through the third pilot line 81C and the fourth pilot line 81D.

The first restriction 70A is disposed between the first working connection 50A and the first bypass connection 20A, controlling bypass flow from the first working connection 50A to the first bypass passage 30A and the tank 1. The second restriction 70B is disposed between the second working connection 50B and the second bypass connection 20B, regulating bypass flow from the second working connection 50B to the second bypass passage 30B and the tank 1. The third restriction 70C is disposed between the third working connection 50C and the third bypass connection 20C, limiting bypass flow from the third working connection 50C to the third bypass passage 30C. The fourth restriction 70D is disposed between the fourth working connection 50D and the fourth bypass connection 20D, controlling bypass flow from the fourth working connection 50D to the fourth bypass passage 30D.

The restrictions 70A, 70B, 70C, and 70D operate in conjunction with the pilot operated check valves to provide controlled bypass flow while maintaining actuator position control. When the first control valve 11 is in the first state 11A0, both the first restriction 70A and the second restriction 70B regulate bypass flow from their respective working connections to the first tank passage 1B and the second tank passage 1C, while the first pilot operated check valve 80A and the second pilot operated check valve 80B prevent flow from the actuator ports to the working connections. When the first control valve 11 transitions to actuated states, the restrictions continue to provide controlled bypass flow from the working connection that remains connected to its bypass connection, while the pilot operated check valves respond to pilot pressure to permit controlled flow direction based on the actuated state.

An electronically controlled valve is disposed in the first working passage 40A, the second working passage 40B, the third working passage 40C, or the fourth working passage 40D to provide electronic control of flow direction independent of pilot pressure conditions. The electronically controlled valve is commandable when the first control valve 11 or the second control valve 12 is in the first state 11A0, the second state 11A1, or the third state 11A2, providing electronic override of mechanical valve positioning. The electronically controlled valve responds independently to an operator input through manual controls or to a control signal generated by system sensors or control algorithms, enabling precise flow control based on operational requirements or system conditions.

The pilot operated check valves 80A, 80B, 80C, and 80D are alternatively implemented using counterbalance valves that provide load-holding capability while permitting controlled flow when pilot pressure is applied. Counterbalance valves incorporate internal pilot ratios that determine the pilot pressure required to open the valve based on load pressure, providing enhanced control of actuator movement under varying load conditions. Pilot operated sequence valves are used as alternatives to the pilot operated check valves, providing pressure-responsive operation that opens when pilot pressure exceeds predetermined thresholds while maintaining closed positions when pilot pressure is insufficient.

Other pressure responsive valve types include pilot operated relief valves that provide pressure-controlled flow regulation based on pilot pressure signals, and pilot operated flow control valves that regulate flow rates in response to pilot pressure variations. Pilot actuated valve types include solenoid pilot operated valves that respond to electrical pilot signals, hydraulic pilot operated valves that respond to hydraulic pilot pressure, and pneumatic pilot operated valves that respond to pneumatic pilot pressure. The various valve types achieve similar functionality by providing controlled flow direction based on external control signals while preventing unintended flow when control signals are absent, ensuring actuator position control and preventing drift during neutral valve positions.

Referring to FIG. 8, the check valve 110 is disposed within the free flow passage 111 between the second free flow connection 60 of the first control valve 11 and the third free flow connection 12F of the second control valve 12. The check valve 110 establishes unidirectional flow control within the series circuit by permitting hydraulic fluid flow from the first control valve 11 to the second control valve 12 while preventing reverse flow from the second control valve 12 back to the first control valve 11. The check valve 110 maintains controlled flow direction within the series circuit during multifunction operation when both the first control valve 11 and the second control valve 12 are actuated simultaneously.

The check valve 110 prevents backflow conditions that occur when downstream actuators create pressure buildup within the series flow path. When the first control valve 11 operates in the second state 11A1 and the second control valve 12 operates in the fourth state 12A1, return flow from the first working connection 50A is directed through the second free flow connection 60, through the check valve 110 within the free flow passage 111, and to the third free flow connection 12F of the second control valve 12. The check valve 110 ensures that pressure generated within the second control valve 12 cannot propagate backward through the free flow passage 111 to the first control valve 11, preventing unintended pressure effects on upstream actuator operation.

With continued reference to FIG. 8, during multifunction operation when multiple control valves are actuated simultaneously, the check valve 110 maintains flow priority by preventing reverse flow from downstream valve sections back to upstream valve sections. When the second control valve 12 directs pressurized fluid to actuator circuits while receiving series flow from the first control valve 11, the check valve 110 isolates the upstream series flow path from downstream pressure variations. The unidirectional flow control provided by the check valve 110 ensures that series flow continues from the first control valve 11 to the second control valve 12 without interference from downstream pressure conditions or valve positioning.

The first bypass passage 30 and the second bypass passage 31 continue to provide return paths to the tank 1A through the first tank passage 1B and the second tank passage 1C respectively, operating independently of the check valve 110 within the free flow passage 111. The first bypass passage 30 routes return flow from the first control valve 11 directly to the tank 1A, while the second bypass passage 31 routes return flow from the second control valve 12 directly to the tank 1A. The bypass passages 30 and 31 function as alternative flow paths that remain available when the check valve 110 restricts reverse flow within the series circuit, ensuring that upstream actuator operation continues even when downstream actuators become stalled or reach the end of their stroke.

The check valve 110 operates in conjunction with the bypass passages 30 and 31 to provide comprehensive flow management during multifunction hydraulic operation. When downstream actuators controlled by the second control valve 12 create backpressure within the series flow path, the check valve 110 prevents this pressure from affecting upstream actuator operation through the first control valve 11. Simultaneously, the first bypass passage 30 provides an alternative return path for fluid from the first control valve 11, allowing continued upstream actuator motion while the check valve 110 maintains flow direction control within the series circuit. The second bypass passage 31 provides similar bypass functionality for the second control valve 12, ensuring that return flow from downstream actuators reaches the tank 1A through the second tank passage 1C without creating pressure buildup that could affect series flow operation.

Multiple check valves are disposed within the free flow passage 111 or within parallel series channels to provide enhanced reverse flow prevention and system reliability. Additional check valves are positioned between the fourth free flow connection 61 of the second control valve 12 and subsequent downstream control valves, maintaining unidirectional flow control throughout the entire series circuit. The multiple check valve configuration ensures that each valve section within the series circuit operates independently without interference from downstream pressure conditions, while the bypass passages 30 and 31 continue to provide controlled return flow paths to the tank 1A through the first tank passage 1B and the second tank passage 1C.

Referring to FIG. 9, the machine 2 represents a working machine configured to utilize the hydraulic valve system for controlling multiple hydraulic actuators in material handling operations. The machine 2 includes the cab 3 positioned on the chassis 4 to house an operator and operator controls for directing machine functions. The chassis 4 serves as the primary structural framework that supports all machine components and provides mounting points for the hydraulic actuators and linkage systems. The front wheel 5 and the rear wheel 6 support the chassis 4 and provide mobility for the machine 2 across various terrain conditions.

The chassis 4 incorporates the cylinder pivot point 7 and the boom pivot point 8 as structural mounting locations for the hydraulic boom system. The boom 9 is pivotally connected to the chassis 4 at the boom pivot point 8, enabling rotational movement about this fixed axis. The boom cylinder 14 extends between the cylinder pivot point 7 on the chassis 4 and the boom cylinder pivot point 15 on the boom 9, creating a hydraulic actuator arrangement that controls boom positioning through extension and retraction cycles.

The boom cylinder 14 operates under control of the hydraulic valve system to direct pressurized hydraulic fluid to either end of the cylinder, causing the boom 9 to rotate about the boom pivot point 8. Extension of the boom cylinder 14 forces the boom 9 to rotate counterclockwise about the boom pivot point 8, lifting the boom and any attached implements. Retraction of the boom cylinder 14 causes the boom 9 to rotate clockwise about the boom pivot point 8, lowering the boom toward the ground or operating position.

The bucket 19 is pivotally attached to the distal end of the boom 9 at the bucket pivot point 18, providing a second degree of freedom for implement positioning and operation. The bucket cylinder 17 extends between the bucket cylinder pivot point 16 on the boom 9 and the bucket cylinder rod pivot point 22 on the bucket 19, establishing hydraulic control over bucket orientation and movement. The bucket cylinder pivot point 16 provides a fixed mounting location on the boom 9, while the bucket cylinder rod pivot point 22 connects the cylinder rod to the bucket 19 structure.

The bucket cylinder 17 operates under control of the hydraulic valve system to position the bucket 19 relative to the boom 9 through controlled extension and retraction. Extension of the bucket cylinder 17 causes the bucket 19 to rotate clockwise about the bucket pivot point 18, creating a dumping motion that empties material from the bucket. Retraction of the bucket cylinder 17 causes the bucket 19 to rotate counterclockwise about the bucket pivot point 18, creating a curling motion that scoops material into the bucket or maintains material retention during transport operations.

The front wheel 5 and the rear wheel 6 are implemented in various configurations based on operational requirements and terrain conditions. Wheeled undercarriage configurations utilize pneumatic tires or solid rubber tires mounted on wheel assemblies that provide mobility across paved surfaces, gravel, and moderate terrain conditions. Tracked undercarriage configurations replace the front wheel 5 and the rear wheel 6 with continuous track systems that distribute machine weight over larger ground contact areas, providing enhanced traction and reduced ground pressure for operation in soft soil, mud, or unstable terrain conditions.

The hydraulic valve system controls the boom cylinder 14 and the bucket cylinder 17 through the series-connected circuit arrangement described in the preceding embodiments. The boom cylinder 14 connects to the hydraulic valve system through the boom base port and the boom rod port, receiving pressurized hydraulic fluid and directing return flow back to the valve system. The bucket cylinder 17 connects to the hydraulic valve system through corresponding ports that enable series operation where return flow from the boom cylinder 14 is directed to supply the bucket cylinder 17 during simultaneous operation.

Additional attachments are installed in place of the bucket 19 to expand machine functionality and operational capabilities. Hydraulic trencher attachments replace the bucket 19 and connect to the bucket cylinder 17 for fore/aft tilting control while incorporating additional hydraulic motors or cylinders for trenching operations. Grapple bucket attachments include hydraulic cylinders that operate grapple arms or tines for material handling applications, with the grapple cylinders controlled through auxiliary hydraulic circuits while the bucket cylinder 17 continues to provide tilting control.

Other hydraulically operated tools include hydraulic hammers, augers, brush cutters, snow blowers, and specialized material handling attachments that connect to the boom 9 at the bucket pivot point 18. These attachments utilize the bucket cylinder 17 for positioning control while incorporating additional hydraulic actuators that connect to auxiliary hydraulic circuits within the hydraulic valve system. The attachment actuator described in the preceding embodiments represents these auxiliary hydraulic functions that operate in conjunction with the boom cylinder 14 and the bucket cylinder 17 through the series-connected hydraulic circuit.

The machine 2 demonstrates the practical application of the hydraulic valve system in controlling multiple hydraulic actuators through series-connected circuits with selective bypass functionality. The boom cylinder 14 and the bucket cylinder 17 operate simultaneously during material handling operations, with return flow from the boom cylinder 14 directed to supply the bucket cylinder 17 while bypass passages provide alternative flow paths to prevent stalling when actuators reach the end of their stroke. The hydraulic valve system enables coordinated control of the boom 9 and the bucket 19 while maintaining operational flexibility through the bypass connections that remain available across neutral and actuated valve positions.

Referring to FIG. 10, the valve section S1 is configured as a modular hydraulic component that incorporates comprehensive internal passage routing to enable selective bypass functionality while maintaining series flow capability. The supply interface 155A receives pressurized hydraulic fluid from an external pump source and directs the fluid through the supply passage 10A to the first free flow connection 11F within the first control valve 11. The outlet supply interface 155B provides fluid communication to downstream valve sections or actuators through internal passage connections that route fluid from the valve section S1 to subsequent hydraulic components within the series circuit.

The supply passage 10A establishes the primary fluid delivery path from the supply interface 155A to the first free flow connection 11F, enabling pressurized hydraulic fluid to enter the first control valve 11 for distribution to actuator circuits or downstream valve sections. The first free flow connection 11F serves as the inlet point for pressurized fluid within the first control valve 11 and connects to internal valve passages that direct fluid flow based on the operational state of the control valve. The outlet supply interface 155B connects to internal passages that receive fluid from the second free flow connection 60 and the first free flow passage 60A, routing series flow and bypass return flow toward downstream hydraulic components.

The first working passage 40A extends from the first working connection 50A to external actuator connections, providing a fluid communication path for hydraulic fluid delivery to and return from hydraulic actuators. The second working passage 40B extends from the second working connection 50B to external actuator connections, establishing a separate fluid communication path for the opposite side of hydraulic actuators or for independent actuator control. The first working passage 40A and the second working passage 40B operate independently to enable bidirectional actuator control while maintaining separate flow paths for supply and return fluid routing.

The first bypass connection 20A connects to the first bypass passage 30A, which provides a controlled flow path from the first working connection 50A toward tank return passages. The second bypass connection 20B connects to the second bypass passage 30B, establishing a separate controlled flow path from the second working connection 50B toward tank return passages. The first bypass passage 30A and the second bypass passage 30B operate as independent bypass routes that enable return flow from actuators to reach tank connections while maintaining separate flow control for each working connection within the valve section S1.

The first flow control element 114 is positioned within the first bypass passage 30A and regulates fluid flow through the first drain passage 113A to the first tank passage 1B. The first flow control element 114 operates as a pressure-responsive or flow-limiting device that controls the rate at which hydraulic fluid flows from the first bypass connection 20A to the first tank passage 1B, preventing excessive bypass flow while ensuring adequate flow capacity during normal operation. The second flow control element 115 is positioned within the second bypass passage 30B and regulates fluid flow through the second drain passage 113B to the second tank passage 1C, providing independent flow control for the second bypass path.

The first drain passage 113A connects the first flow control element 114 to the first tank passage 1B, establishing a controlled flow path that enables hydraulic fluid to return to tank through the first bypass passage 30A when the first flow control element 114 permits flow. The second drain passage 113B connects the second flow control element 115 to the second tank passage 1C, providing a separate controlled return path for hydraulic fluid flowing through the second bypass passage 30B. The first tank passage 1B and the second tank passage 1C connect to external tank interfaces that route return fluid back to the hydraulic system reservoir.

The first bypass check valve 117 is disposed within the first free flow bypass passage 112A and directs return flow from the first bypass passage 30A toward the second free flow connection 60 through the third free flow bypass passage 118. The first bypass check valve 117 permits fluid flow from the first bypass passage 30A toward the second free flow connection 60 while preventing reverse flow from the second free flow connection 60 back into the first bypass passage 30A. The second bypass check valve 116 is disposed within the second free flow bypass passage 112B and directs return flow from the second bypass passage 30B toward the second free flow connection 60 through the fourth free flow bypass passage 119.

The first free flow bypass passage 112A connects the first bypass passage 30A to the first bypass check valve 117, enabling return flow from the first working connection 50A to be directed toward series flow routing through the third free flow bypass passage 118. The second free flow bypass passage 112B connects the second bypass passage 30B to the second bypass check valve 116, providing a parallel flow path that enables return flow from the second working connection 50B to be directed toward series flow routing through the fourth free flow bypass passage 119. The third free flow bypass passage 118 and the fourth free flow bypass passage 119 converge at the second free flow connection 60, combining bypass return flow from both working connections into a unified series flow path.

The second free flow connection 60 receives fluid from the third free flow bypass passage 118 and the fourth free flow bypass passage 119, consolidating bypass return flow from both the first working connection 50A and the second working connection 50B into a single flow stream that continues through the first free flow passage 60A toward the outlet supply interface 155B. The first free flow passage 60A connects the second free flow connection 60 to the outlet supply interface 155B, enabling series flow to continue from the valve section S1 to downstream valve sections or actuators within the hydraulic circuit.

The first inlet tank interface 154A and the second inlet tank interface 154C provide connections to upstream tank passages that route return fluid from preceding valve sections or system components. The first outlet tank interface 154B and the second outlet tank interface 154D provide connections to downstream tank passages that continue tank return flow toward subsequent valve sections or directly to the hydraulic system reservoir. The tank interfaces 154A, 154B, 154C, and 154D establish continuous tank return paths through the valve section S1 that operate independently of the bypass passages and series flow routing.

The first port relief valve 153A provides pressure relief for the first working passage 40A by opening when pressure within the passage exceeds a predetermined threshold, allowing excess pressure to be relieved to the first tank passage 1B. The second port relief valve 153B provides pressure relief for the second working passage 40B through similar pressure-responsive operation, relieving excess pressure to the second tank passage 1C when pressure thresholds are exceeded. The first port relief valve 153A and the second port relief valve 153B operate independently to protect actuators and system components from excessive pressure conditions while maintaining normal flow operation through the working passages.

The bypass to free flow connections within the valve section S1 are implemented using the first bypass check valve 117 and the second bypass check valve 116 in conjunction with the first free flow bypass passage 112A, the second free flow bypass passage 112B, the third free flow bypass passage 118, and the fourth free flow bypass passage 119. This check valve implementation ensures unidirectional flow from the bypass passages toward the second free flow connection 60 while preventing reverse flow that could interfere with bypass operation. Alternative implementations utilize a common gallery that connects both the first bypass passage 30A and the second bypass passage 30B to the second free flow connection 60 through a shared internal chamber or manifold passage.

Individual passage implementations establish separate dedicated passages from the first bypass passage 30A and the second bypass passage 30B to the second free flow connection 60 without intermediate check valves, relying on valve positioning and internal flow control to prevent reverse flow conditions. Merged passage implementations combine the first free flow bypass passage 112A and the second free flow bypass passage 112B into a single passage that connects to the second free flow connection 60, reducing the number of internal passages while maintaining bypass to free flow connectivity. Direct passage implementations eliminate intermediate passages and connect the first bypass passage 30A and the second bypass passage 30B directly to the second free flow connection 60 through machined passages or cast features within the valve body.

The various bypass to free flow connection methods provide design flexibility that accommodates different valve body configurations, manufacturing processes, and performance requirements. Check valve implementations provide positive flow direction control and prevent reverse flow under all operating conditions, while common gallery implementations simplify internal passage routing and reduce manufacturing complexity. Individual passage implementations provide independent flow control for each bypass path, while merged passage implementations reduce internal complexity while maintaining functional performance. Direct passage implementations minimize flow restrictions and pressure losses while relying on valve design and positioning to maintain proper flow direction during operation.

Referring to FIGS. 11A and 11B, the valve section S1 includes internal components arranged in a sectional view configuration that demonstrates the neutral state operation of the spool 150. The first supply interface 120 receives pressurized hydraulic fluid from an external pump source and distributes the fluid through internal supply passages to establish pressurized fluid availability throughout the valve section S1. The first supply passage 121A extends from the first supply interface 120 to the first free flow connection port 151A, providing a primary fluid delivery path that enables pressurized hydraulic fluid to enter the valve section S1. The second supply passage 121B extends from the first supply interface 120 to the second free flow connection port 151B, establishing a parallel fluid delivery path that provides redundant supply capability and enhanced flow capacity for downstream hydraulic components.

The outlet supply interface 122A provides fluid communication to downstream valve sections or actuators through the first free flow passage 122B, which connects internally to the third free flow connection port 144. The first free flow passage 122B establishes the primary outlet flow path from the valve section S1 to subsequent hydraulic components within the series circuit. The third free flow connection port 144 serves as the outlet point for both series flow and bypass return flow, consolidating fluid streams from multiple internal passages into a unified flow path that continues through the outlet supply interface 122A to downstream hydraulic components.

The first free flow connection port 151A and the second free flow connection port 151B receive pressurized fluid from the first supply passage 121A and the second supply passage 121B respectively, establishing dual inlet points for hydraulic fluid within the valve section S1. The third supply passage 129A connects to the first free flow connection port 151A, while the fourth supply passage 129B connects to the second free flow connection port 151B, providing internal fluid distribution paths that route pressurized fluid to various valve functions based on the operational state of the spool 150.

The spool 150 is positioned within the valve section S1 in the neutral state and includes the first bypass feature 127A and the second bypass feature 127A. The first bypass feature 127A consists of a notch, groove, spiral scratch, or other machined geometry that establishes fluid communication between the first working connection port 124A and the first bypass connection port 125A when the spool 150 is in the neutral position. The second bypass feature 127B consists of a notch, groove, spiral scratch, or other machined geometry that establishes fluid communication between the second working connection port 124B and the second bypass connection port 125B in the neutral state. The first bypass feature 127A and the second bypass feature 127B are distinct machined flow paths that are intentionally incorporated into the spool 150 and are not formed by nominal spool to bore clearance.

The first working connection port 124A connects to the first working passage 132A, which extends to the first work port 133A for external actuator connections. The second working connection port 124B connects to the second working passage 132B, which extends to the second work port 133B for independent actuator control or opposite side actuator connections. The first working passage 132A and the second working passage 132B operate as separate fluid communication paths that enable bidirectional actuator control while maintaining independent flow routing for supply and return fluid.

The first bypass connection port 125A connects to the first bypass passage 145A, establishing a controlled flow path from the first working connection port 124A toward tank return passages when the first bypass feature 127A provides fluid communication in the neutral state. The second bypass connection port 125B connects to the third bypass passage 145B, providing a separate controlled flow path from the second working connection port 124B toward tank return passages when the second bypass feature 127B establishes fluid communication in the neutral state. The first bypass passage 145A and the third bypass passage 145B operate as independent bypass routes that direct return flow from working connections toward tank passages through downstream flow control elements.

The first flow control element 138A is positioned within the first bypass passage 145A and regulates fluid flow from the first bypass connection port 125A toward the first tank passage 146A. The first flow control element 138A creates the second bypass passage 139A downstream of the flow control element, establishing a controlled flow path that continues from the first flow control element 138A to the first tank passage 146A. The second flow control element 138B is positioned within the third bypass passage 145B and regulates fluid flow from the second bypass connection port 125B toward the second tank passage 146B. The second flow control element 138B creates the fourth bypass passage 139B downstream of the flow control element, providing a controlled continuation path from the second flow control element 138B to the second tank passage 146B.

The first tank passage 146A receives controlled bypass flow from the second bypass passage 139A and routes return fluid toward external tank connections for hydraulic system reservoir return. The second tank passage 146B receives controlled bypass flow from the fourth bypass passage 139B and provides a separate tank return path that operates independently of the first tank passage 146A. The first tank passage 146A and the second tank passage 146B establish dual tank return capabilities that distribute bypass flow across separate return paths, reducing flow restrictions and enhancing system response during neutral state operation.

The load check valve 143 is positioned between the third supply passage 129A and the fourth supply passage 129B and the first pressure supply passage 130A and the second pressure supply passage 130B. The load check valve 143 permits fluid flow from the third supply passage 129A and the fourth supply passage 129B to the first pressure supply passage 130A and the second pressure supply passage 130B when supply pressure exceeds a predetermined bias threshold. The load check valve 143 prevents reverse flow from the first pressure supply passage 130A and the second pressure supply passage 130B back to the third supply passage 129A and the fourth supply passage 129B, maintaining pressure isolation and preventing backflow conditions during valve operation.

The first pressure supply passage 130A connects to the first pressure supply connection port 123A, establishing a pressurized fluid delivery path that becomes active when the spool 150 transitions from the neutral state to actuated positions. The second pressure supply passage 130B connects to the second pressure supply connection port 123B, providing a separate pressurized fluid delivery path for opposite direction actuator control. The first pressure supply connection port 123A and the second pressure supply connection port 123B remain isolated from the first working connection port 124A and the second working connection port 124B respectively when the spool 150 is in the neutral state, preventing pressurized fluid delivery to actuator circuits during neutral operation.

The first bypass check valve 141A is positioned between the first bypass check inlet port 140A and the first bypass check outlet port 142A, establishing unidirectional flow control for bypass return flow routing. The first bypass check inlet port 140A receives fluid from the first bypass passage 145A, while the first bypass check outlet port 142A directs flow toward the second free flow passage 149. The second bypass check valve 141B is positioned between the second bypass check inlet port 140B and the second bypass check outlet port 142B, providing parallel unidirectional flow control for the second bypass path. The second bypass check inlet port 140B receives fluid from the third bypass passage 145B, while the second bypass check outlet port 142B directs flow toward the second free flow passage 149.

The second free flow passage 149 receives fluid from both the first bypass check outlet port 142A and the second bypass check outlet port 142B, consolidating bypass return flow from both working connection ports into a unified flow stream. The second free flow passage 149 connects to the third free flow connection port 144, enabling bypass return flow to continue through the first free flow passage 122B toward the outlet supply interface 122A for downstream routing. The first bypass check valve 141A and the second bypass check valve 141B prevent reverse flow from the second free flow passage 149 back into the first bypass passage 145A and the third bypass passage 145B respectively, maintaining proper flow direction during neutral state operation.

The first work port branch passage 134A connects the first work port 133A to the first work port pressure control valve 135A, establishing a pressure monitoring and relief path for the first working circuit. The second work port branch passage 134B connects the second work port 133B to the second work port pressure control valve 135B, providing parallel pressure monitoring and relief capability for the second working circuit. The first work port pressure control valve 135A and the second work port pressure control valve 135B operate independently to monitor pressure conditions at the first work port 133A and the second work port 133B respectively.

The first low pressure tank passage 136A connects the first work port pressure control valve 135A to the first low pressure tank port 126A, providing a controlled pressure relief path when pressure at the first work port 133A exceeds predetermined thresholds. The second low pressure tank passage 136B connects the second work port pressure control valve 135B to the second low pressure tank port 126B, establishing a separate pressure relief path for the second working circuit. The first low pressure tank port 126A and the second low pressure tank port 126B provide external connections to low pressure tank return lines that operate independently of the primary tank passages 146A and 146B.

The first machined passage 128A and the second machined passage 128B are formed within the valve body and spool geometry to facilitate fluid communication between the first free flow connection port 151A and the second free flow connection port 151B and the third free flow connection port 144 when the spool 150 is in the neutral state. The first machined passage 128A provides a primary flow path that enables pressurized fluid to flow from the first free flow connection port 151A through the spool 150 toward the third free flow connection port 144. The second machined passage 128B provides a parallel flow path that enables pressurized fluid to flow from the second free flow connection port 151B through the spool 150 toward the third free flow connection port 144, maintaining free flow operation during neutral state positioning.

Referring to FIGS. 12A and 12B, the valve section S1 is shown in the second operational state where the spool 150 has been shifted from the neutral position to supply hydraulic fluid to the first work port 133A. The spool 150 establishes fluid communication between the first pressure supply connection port 123A and the first working connection port 124A through internal spool geometry that aligns supply passages with working passages when the spool 150 is displaced from the neutral position. The first pressure supply connection port 123A receives pressurized fluid from the first pressure supply passage 130A, which is supplied through the load check valve 143 from the third supply passage 129A and the fourth supply passage 129B.

The load check valve 143 permits fluid flow from the third supply passage 129A and the fourth supply passage 129B to the first pressure supply passage 130A and the second pressure supply passage 130B when supply pressure exceeds the predetermined bias threshold of the load check valve 143. The load check valve 143 opens to allow pressurized fluid to flow from the supply passages 129A and 129B into the pressure supply passages 130A and 130B, establishing pressurized fluid availability at the first pressure supply connection port 123A and the second pressure supply connection port 123B for actuator supply when the spool 150 transitions to actuated positions.

The spool 150 blocks the connection between the first working connection port 124A and the first bypass connection port 125A when positioned in the second operational state. The first bypass feature 127A no longer provides fluid communication between the first working connection port 124A and the first bypass connection port 125A, as the spool displacement eliminates the alignment between these connection ports that existed during neutral state operation. The blocking of this connection prevents return flow from the first working connection port 124A from reaching the first bypass connection port 125A and the first bypass passage 145A.

Return flow from the second work port 133B passes through the second working passage 132B to the second working connection port 124B during the second operational state. The second working passage 132B provides a direct fluid communication path that enables hydraulic fluid displaced from actuators connected to the second work port 133B to return to the valve section S1 through the second working connection port 124B. The return flow continues from the second working connection port 124B through the second bypass feature 127B to the second bypass connection port 125B, as the second bypass feature 127B maintains fluid communication between these connection ports when the spool 150 is in the second operational state.

The return flow continues from the second bypass connection port 125B through the third bypass passage 145B toward the second flow control element 138B. The third bypass passage 145B provides a controlled flow path that directs return fluid from the second bypass connection port 125B to the second flow control element 138B, which regulates flow based on pressure conditions or flow control requirements. The return flow passes through the second flow control element 138B and continues through the fourth bypass passage 139B toward the second tank passage 146B, establishing a controlled bypass flow path to tank return.

Simultaneously, the return flow from the second bypass connection port 125B is directed through the second bypass check inlet port 140B to the second bypass check valve 141B. The second bypass check inlet port 140B receives fluid from the third bypass passage 145B and directs the flow to the second bypass check valve 141B, which permits unidirectional flow toward the second bypass check outlet port 142B. The second bypass check valve 141B prevents reverse flow from the second bypass check outlet port 142B back to the second bypass check inlet port 140B while allowing forward flow to continue toward series flow routing.

The return flow continues from the second bypass check outlet port 142B through the second free flow passage 149 to the third free flow connection port 144. The second free flow passage 149 consolidates return flow from the second bypass check outlet port 142B and directs the flow toward the third free flow connection port 144, which serves as the outlet point for series flow continuation. The third free flow connection port 144 connects to the outlet supply interface 122A through the first free flow passage 122B, enabling return flow to continue from the valve section S1 to downstream valve sections or actuators within the series circuit.

The machined passages within the spool 150 enable state-dependent flow routing by providing selective fluid communication paths that change based on spool position. The first machined passage 128A and the second machined passage 128B facilitate fluid communication between connection ports when the spool 150 is positioned to align internal passages with external connection points. The machined passages are formed within the spool geometry to establish controlled flow paths that connect supply passages to working passages during actuated states while maintaining bypass connectivity through the bypass features 127A and 127B.

The spool 150 incorporates internal cutouts and passages that selectively connect the first pressure supply connection port 123A to the first working connection port 124A when positioned in the second operational state. The internal spool geometry aligns supply passages with working passages to enable pressurized fluid delivery to actuator circuits while simultaneously maintaining bypass connectivity for return flow routing. The spool design ensures that the second bypass feature 127B continues to provide fluid communication between the second working connection port 124B and the second bypass connection port 125B, enabling dual flow path operation where return flow is directed both to tank through the bypass passages and to downstream components through the series flow passages.

The control element within the valve section S1 consists of the spool 150, which operates as a sliding element that selectively establishes fluid communication between passages and ports based on axial positioning within the valve body. The spool 150 functions as a poppet, rotary element, sliding plate, or other device capable of selectively establishing fluid communication between the passages and ports within the valve section S1. Control of the spool 150 is mechanical, hydraulic, pneumatic, electric, electrohydraulic, or a combination thereof, enabling precise positioning control based on operator input or system control signals.

The valve section S1 comprises internal flow paths that are integrated into a single valve body, such as a casting, manifold, or machined block that incorporates all control valves and internal flow passages within a unified structure. The bypass to free flow connections are implemented using the first bypass check valve 141A and the second bypass check valve 141B in conjunction with the bypass check inlet ports 140A and 140B, the bypass check outlet ports 142A and 142B, and the second free flow passage 149. The check valve implementation provides unidirectional flow control while alternative implementations utilize a common gallery, individual passages, merged passages, or direct passages without check valves based on specific design requirements and performance objectives.

The second flow control element 138B operates as a pressure control valve, check valve, pilot operated valve, restrictor, orifice, compensator, or other flow regulating element that controls flow from the third bypass passage 145B to the fourth bypass passage 139B. Flow control functionality is achieved using any suitable device that provides appropriate flow regulation characteristics based on system requirements and operational conditions. The second flow control element 138B includes a restriction configured to limit the amount of hydraulic fluid flow directed through the bypass to tank, ensuring controlled bypass flow rates that do not interfere with series operation or create excessive pressure losses within the bypass passages.

Multiple pressure control valves are disposed within the bypass passages to provide a stepped response to rising system pressure or load conditions. Higher pressure stages progressively open additional bypass capacity as needed, creating a graduated pressure response that matches bypass flow capacity to system demand during varying operational conditions. An orifice is disposed in parallel with the pressure control valves to provide a response that is clipped when a given pressure in the series channel is achieved, allowing a controlled blend of fixed-orifice flow and pressure-responsive flow regulation that ensures bypass flow availability across all operating pressures.

An electronically controlled valve is placed within the bypass passages to allow hydraulic fluid to flow to tank when an electronic signal is provided to the valve. The electronically controlled valve operates independently of pressure conditions and responds to operator input or system control signals to provide selective bypass flow control. An electronically controlled valve is disposed within the working passages and is commandable when the spool 150 is in the neutral, second operational, or third operational state, or operates independently in response to an operator input or control signal that overrides mechanical valve positioning.

Each of the bypass passages includes a restriction that provides redundant operation in the case that one orifice becomes plugged with contamination and continued operation when the orifices remain unobstructed. The restrictions within parallel bypass passages operate together to maintain bypass flow capability even when individual restrictions experience blockage, ensuring continued system operation and preventing complete loss of bypass functionality during contamination events or component failures.

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A hydraulic system for a machine, comprising:
a tank operable to store a hydraulic fluid;
a first pump operable to output a flow of hydraulic fluid;
a first hydraulic actuator having a first fluid port and a second fluid port for receiving the hydraulic fluid to move the first hydraulic actuator in respective first and second directions;
a second hydraulic actuator having a third fluid port and a fourth fluid port for receiving the hydraulic fluid to move the second hydraulic actuator in respective first and second directions;
a first control valve disposed to control the first hydraulic actuator and controllable among at least a first state and a second state, the first control valve comprising:
a control element;
a first supply connection fluidly connected to the first pump via a supply passage;
a first free flow connection fluidly connected to the first pump via the supply passage;
a second free flow connection fluidly connectable to a downstream hydraulic component;
a first working connection and a second working connection;
a first working passage fluidly connecting the first working connection to the first fluid port;
a second working passage fluidly connecting the second working connection to the second fluid port;
at least one bypass connection; and
at least one bypass passage fluidly connecting the at least one bypass connection to the tank;
wherein at least one of the first working connection, the second working connection, and the bypass connection is positioned proximate to the control element at one or more positions thereon and is selectively connectable through one or more internal passage configurations within the first control valve;
a second control valve disposed downstream of the first control valve and controllable among at least a first state and a second state to control the second hydraulic actuator, the second control valve being fluidly connected to the first control valve via the second free flow connection and comprising:
a third free flow connection fluidly connected to the second free flow connection;
a fourth free flow connection fluidly connectable to a further downstream hydraulic component or to the tank;
a third working connection and a fourth working connection;
a third working passage fluidly connecting the third working connection to the third fluid port; and
a fourth working passage fluidly connecting the fourth working connection to the fourth fluid port;
wherein, in the first state of the first control valve:
the first free flow connection is fluidly connected to the second free flow connection to deliver fluid output from the first pump through the first control valve to the third free flow connection of the second control valve;
the first supply connection is blocked; and
the first working connection and the second working connection are each fluidly connected to the at least one bypass connection so that fluid from the first hydraulic actuator is returnable to the tank via the at least one bypass passage; and
wherein, in the second state of the first control valve:
a fluid connection between the first working connection and the at least one bypass connection is at least partially closed;
the first working connection is fluidly connected to the first supply connection to allow fluid communication between the first pump and the first working passage to supply the first hydraulic actuator through the first fluid port;
the second working connection is fluidly connected to the at least one bypass connection; and
the second working connection is fluidly connected, directly or indirectly, to the second free flow connection through one or more internal passages, bypass passages, check valves, pressure-control valves, or other flow-permissive elements of the valve, thereby allowing fluid communication among the second working passage, the at least one bypass passage, and the second free flow connection.

2. The hydraulic system of claim 1, wherein the first control valve is controllable among a third state, and wherein, in the third state of the first control valve:
a fluid connection between the second working connection and the at least one bypass connection is at least partially closed;
the second working connection is fluidly connected to the first supply connection to allow fluid communication between the first pump and the second working passage;
the first working connection is fluidly connected to the at least one bypass connection; and
the first working connection is fluidly connected, directly or indirectly, to the second free flow connection through one or more internal passages, bypass passages, check valves, pressure control valves, or other flow permissive elements of the valve, thereby allowing fluid communication between the first working passage, the at least one bypass passage, and the second control valve via the second free flow connection.

3. The hydraulic system of claim 1, wherein the second control valve is configured in like manner to the first control valve and comprises:
the third free flow connection and the fourth free flow connection corresponding to the first and second free flow connections of the first control valve;
the third and fourth working connections corresponding to the first and second working connections;
the third and fourth working passages corresponding to the first and second working passages;
a second supply connection corresponding to the first supply connection; and
at least one bypass connection and at least one bypass passage corresponding to those of the first control valve, the second control valve being operable among corresponding first, second, and third states.

4. The hydraulic system of claim 1, wherein the at least one bypass passage comprises:
a first bypass passage and a second bypass passage, each independently associated with the first working connection of the first control valve or the third working connection of the second control valve; and
a third bypass passage and a fourth bypass passage, each independently associated with the second working connection of the first control valve or the fourth working connection of the second control valve.

5. The hydraulic system of claim 4, wherein:
a first restriction and a second restriction are disposed between the first working connection or the third working connection and the first and second bypass passages, respectively; or
a third restriction and a fourth restriction are disposed between the second working connection or the fourth working connection and the third and fourth bypass passages, respectively, each restriction being configured to limit flow from the corresponding working connection to the tank without impeding flow from the corresponding working connection to a free flow connection.

6. The hydraulic system of claim 4, wherein a respective restriction is disposed within at least one of the first, second, third, or fourth bypass passages.

7. The hydraulic system of claim 1, wherein at least one pressure control valve is disposed in the at least one bypass passage, the pressure control valve comprising at least one of a check valve, a relief valve, a sequence valve, or a compensator, and being configured to direct flow from one or more of the working connections of the first or second control valve to the tank through the at least one bypass passage when a predetermined pressure is exceeded.

8. The hydraulic system of claim 1, wherein the control element of the first control valve comprises a spool, and fluid communication between at least one of the first or second working connections and the at least one bypass connection in the first state and in at least one of the second or third states is provided by a bypass feature formed on the spool, the bypass feature comprising at least one of a notch, a spiral groove, a lateral groove, or another machined flow path distinct from nominal spool to bore clearance.

9. The hydraulic system of claim 1, wherein at least one valve selected from a pilot operated check valve, a pilot operated sequence valve, a counterbalance valve, and an electronically controlled valve is disposed in the first or second working passage of the first control valve or the third or fourth working passage of the second control valve, the at least one valve being configured to remain closed in the first state of the corresponding control valve and to open in the second or third state when hydraulically piloted or electronically commanded.

10. The hydraulic system of claim 9, wherein at least one check valve is disposed between the second free flow connection of the first control valve and the third free flow connection of the second control valve or between the fourth free flow connection of the second control valve and a fifth free flow connection of a third control valve, the at least one check valve being configured to prevent reverse flow from a downstream free flow connection to an upstream free flow connection.

11. A hydraulic valve section comprising:
a first supply interface configured to receive pressurized fluid;
a first free flow passage fluidly connecting the first supply interface to a first free flow connection port and a second free flow connection port;
an outlet supply interface fluidly connected to a third free flow connection port through a second free flow passage;
at least one pressure supply passage fluidly connectable to the first and second free flow connection ports;
a first working connection port fluidly connected to a first work port through a first working passage;
a second working connection port fluidly connected to a second work port through a second working passage;
a first bypass connection port fluidly connected to a first bypass passage;
a second bypass connection port fluidly connected to a second bypass passage;
at least one flow control element disposed in at least one of the first bypass passage or the second bypass passage, the flow control element being configured to regulate flow between the corresponding bypass passage and a corresponding tank passage;
at least one bypass to free flow passage fluidly connecting at least one of the first bypass passage or the second bypass passage to the third free flow connection port in parallel with the corresponding flow control element, the bypass to free flow passage being configured to allow return flow toward the outlet supply interface while the corresponding flow control element directs flow toward the corresponding tank passage; and
a control spool disposed in a spool cavity and movable among at least a neutral state and a plurality of actuated states, the control spool being configured, in the neutral state, to provide fluid communication between the first and second free flow connection ports and the third free flow connection port and to provide fluid communication between the first working connection port and the first bypass connection port and between the second working connection port and the second bypass connection port, and in at least one actuated state to connect a pressure supply passage to one of the first or second working connection ports while maintaining fluid communication between the other working connection port and the corresponding bypass connection port so that return flow is deliverable toward the outlet supply interface and toward the corresponding tank passage.

12. The hydraulic valve section of claim 11, further comprising a first flow control element disposed in the first bypass passage and a second flow control element disposed in the second bypass passage, each flow control element being configured to regulate flow between the corresponding bypass passage and the corresponding tank passage.

13. The hydraulic valve section of claim 11, further comprising at least one bypass check valve disposed between at least one of the first bypass passage or the second bypass passage and the third free flow connection port, the at least one bypass check valve being configured to prevent reverse flow from the third free flow connection port toward the corresponding bypass passage.

14. The hydraulic valve section of claim 13, wherein a first bypass check valve is disposed between the first bypass passage and the third free flow connection port and a second bypass check valve is disposed between the second bypass passage and the third free flow connection port, and wherein outlets of the first and second bypass check valves are fluidly connected to the third free flow connection port through a free flow passage.

15. The hydraulic valve section of claim 11, further comprising a load check valve disposed between at least one supply passage connected to the first and second free flow connection ports and the at least one pressure supply passage, the load check valve being configured to permit flow from the at least one supply passage to the at least one pressure supply passage when pressure exceeds a predetermined bias and to prevent reverse flow.

16. The hydraulic valve section of claim 14, wherein the control spool comprises a first bypass feature configured to provide fluid communication between the first working connection port and the first bypass connection port in the neutral state and a second bypass feature configured to provide fluid communication between the second working connection port and the second bypass connection port in the neutral state, each bypass feature comprising at least one of a notch, a spiral groove, a lateral groove, or another machined flow path distinct from nominal spool to bore clearance.

17. A hydraulic system for controlling hydraulic actuators in a machine, comprising:
a hydraulic fluid tank;
a hydraulic pump fluidly connected to the tank;
a first control valve fluidly connected to the pump and operable among a neutral state, a first actuated state, and a second actuated state, the first control valve comprising:
a first working port and a second working port for connection to a first hydraulic actuator;
a first bypass passage and a second bypass passage each fluidly connected to the tank; and
a series flow passage fluidly connectable to a downstream component;
wherein the first control valve is configured such that:
in the neutral state, both the first working port and the second working port are fluidly connected to both the first bypass passage and the second bypass passage;
in the first actuated state, the first working port is fluidly connected to the pump while the second working port remains fluidly connected to the first bypass passage and is simultaneously fluidly connected to the series flow passage; and
in the second actuated state, the second working port is fluidly connected to the pump while the first working port remains fluidly connected to the second bypass passage and is simultaneously fluidly connected to the series flow passage.

18. The hydraulic system of claim 17, further comprising a second control valve disposed downstream of the first control valve and fluidly connected to the series flow passage, the second control valve being operable to control a second hydraulic actuator using fluid received from the series flow passage of the first control valve.

19. The hydraulic system of claim 18, wherein the second control valve comprises a bypass passage fluidly connected to the tank and is configured to direct return flow from the second hydraulic actuator simultaneously to the tank through the bypass passage and to a further downstream component through a downstream series flow passage.

20. The hydraulic system of claim 19, wherein at least one flow control element is disposed in the first bypass passage or the second bypass passage of the first control valve, the flow control element comprising at least one of a restriction, a pressure control valve, or a check valve configured to regulate flow from the corresponding working port to the tank.
